(19) United States
(12) Patent Application Publication
(10) Pub. No.: US 2012/0221809 A1
(43) Pub. Date: Aug. 30, 2012

(54) STORAGE APPARATUS AND DATA PROCESSING METHOD OF THE SAME

(75) Inventors: Takao Yoshikawa, Odawara (JP); Susumu Tsuruta, Odawara (JP); Tetsuhiro Okabe, Atami (JP); Nobuharu Shibuya, Yokohama (JP)

(73) Assignee: Hitachi, Ltd.

(21) Appl. No.: 13/063,427

(22) PCT Filed: Feb. 28, 2011
(86) PCT No.: PCT/JP2011/001150

§ 371 Date: Mar. 10, 2011

(51) Int. Cl. G06F 12/00

(52) U.S. Cl. 711/155; 711/154; 711/E12.001

(57) ABSTRACT

Comprises a memory control unit which transmits and receives data to and from respective interface control units in accordance with access requests and also controls access to the memory and a buffer which temporarily stores data smaller than 64 B, wherein the memory control unit, during access to the memory, if the processing data to be processed is 64 B, accesses the memory by using the processing data or, if the processing data is data smaller than 64 B, stores the data smaller than 64 B in the buffer, subsequently, if the address of the new processing data which became the processing data is sequential to the address of the data smaller than 64 B stored in the buffer, combines the new processing data and the data of the buffer and, on condition that the combined processing data is 64 B data, writes the combined processing data in the memory.

### TECHNICAL FIELD

The present invention relates to a storage apparatus comprising a function, in accessing a memory temporarily storing data, for processing the data by distinguishing data in access units from data which is not in access units, and to a data processing method of the same.

### BACKGROUND ART

A storage system in which a storage apparatus and a host computer are connected via a network is wellknown. Some of these types of storage apparatuses use a plurality of storage areas configured in access units as a memory corresponding to high-speed accesses, process user data from the host computer in access units, write the data in access units to the memory, subsequently read the data written to the memory from the memory, and transfer the same to the storage apparatus.

In this case, a microprocessor, which controls data input/output processing for the memory, can perform the data input/output processing for the memory in access units, and can access the memory at a high speed.

It should be noted that, as a reference related to this type of technology, for example, there is Patent Literature 1.

### CITATION LIST

### Patent Literature

[Patent Literature 1] U.S. Pat. Publication No. 6,029,226

### SUMMARY OF INVENTION

### Technical Problem

Meanwhile, when managing a plurality of storage devices configuring a storage apparatus in a RAID (Redundant Array of Inexpensive Disks) configuration, for example, the management is sometimes performed by adding data guarantee codes or others to the user data. For example, if data in which an 8 B data guarantee code including a guarantee code or the like is added to 512 B user data which is an integer multiple of 64 B (Bytes) is managed, 520 B of data must be processed inside the storage apparatus.

In this case, to process the data in 64 B access units for the memory, the 520 B data must be split into 64 B portions, which leads to the generation of data smaller than 64 B every time 520 B data is split into the 64 B portions.

In this case, as the conventional technology does not consider the processing in cases where data which is different from the access unit is generated, each time the address of write data smaller than 64 B is generated in accessing the memory, the Read Modify Write (hereinafter also referred to as RMW (Read Modify Write)) operation of first referring to the memory based on the address of the write data smaller than 64 B, reading the 64 B data from the memory, updating the read 64 B data with the write data smaller than 64 B, and writing the updated 64 B write data (the 64 B write data acquired by combining the 64 B data read from the memory with the write data smaller than 64 B) to the memory should be performed.

Therefore, in accessing the memory in access units, each time an access for processing data smaller than 64 B occurs, the RMW operation must be performed, which lowers the memory use efficiency.

The present invention was created in view of the problems of the conventional technology, and an object of the same is to provide a storage apparatus capable of reducing the Read Modify Write operation for the memory and a data processing method of the same.

### Solution to Problem

In order to achieve the foregoing object, the present invention is characterized in that, when the memory control unit performing data input/output processing for a memory accesses the memory, if data smaller than the access unit which does not fall within the access unit is generated among the processing data which is the target of the processing, the data smaller than the access unit is temporarily stored in a buffer, whereupon the input processing data and the data stored in the buffer are combined and, on condition that the combined data is in access units, the combined data is written to the memory.

In this case, if the processing data is configured from a plurality of data and the addresses of each of the data are sequential, and if the data of the last address of the plurality of data is data which is smaller than the access unit, by storing this data in the buffer and then combining the input data and the data stored in the buffer, access unit data can be configured, and the data smaller than the access unit can be prevented from being unnecessarily stored in the buffer. Furthermore, if a certain length of time elapses after the data is stored in the buffer, the data in the buffer can be stored in the memory.

### Advantageous Effects of Invention

According to the present invention, the Read Modify Write operation for the memory can be reduced.

### BRIEF DESCRIPTION OF DRAWINGS

FIG. 1 is a configuration diagram of packets.

FIG. 2 is an operation explanatory diagram explaining the overview of the RMW reduction operation.

FIG. 3 is an operation explanatory diagram explaining the overview of the RMW reduction operation.

FIG. 4 is an operation explanatory diagram explaining the overview of the RMW reduction operation.

FIG. 5 is an operation explanatory diagram explaining the overview of the RMW reduction operation.

FIG. 6 is an operation explanatory diagram explaining the overview of the RMW reduction operation.

FIG. 7 is an operation explanatory diagram of cases where write data is processed by the RMW reduction operation.

FIG. 8 is an operation explanatory diagram of cases where write data is processed by the RMW reduction operation.

FIG. 9 is an operation explanatory diagram of cases where write data is processed by the RMW reduction operation.

FIG. 10 is an operation explanatory diagram of cases where write data is processed by the RMW reduction operation.

FIG. 11 is an operation explanatory diagram of cases where data of the memory is processed by the RMW reduction operation.

FIG. 12 is an operation explanatory diagram of cases where data of the memory is processed by the RMW reduction operation.

FIG. 13 is a block configuration diagram showing the entire configuration of a computer system.

FIG. 14 is a configuration diagram of an LU management table.

FIG. 15 is a configuration diagram explaining the relationship between RAID groups and LUs.

FIG. 16 is a block configuration diagram of LUs.

FIG. 17 is a block configuration diagram of sub-blocks.

FIG. 18 is a block configuration diagram of a disk array control unit.

FIG. 19 is an explanatory diagram explaining the data processing process in the disk array control unit.

FIG. 20 is a block configuration diagram of a memory control unit.

FIG. 21 is a configuration diagram of header information.

FIG. 22 is a configuration diagram of on-off registers separated by addresses.

FIG. 23 is a configuration diagram of on-off registers separated by masters.

FIG. 24 is a flowchart explaining the read processing of the disk array device.

FIG. 25 is a flowchart explaining the write processing of the disk array device.

FIG. 26 is a flowchart explaining the transfer processing of buffer data.

FIG. 27 is a flowchart explaining the read request processing of the memory control unit.

FIG. 28 is a flowchart explaining the write request processing of the memory control unit.

FIG. 29 is a flowchart explaining the processing for determining whether to perform the RMW reduction operation or not in accordance with the access source.

FIG. 30 is a flowchart explaining the processing for determining whether to perform the RMW reduction operation or not in accordance with the destination address.

### DESCRIPTION OF EMBODIMENTS

### SUMMARY OF INVENTION

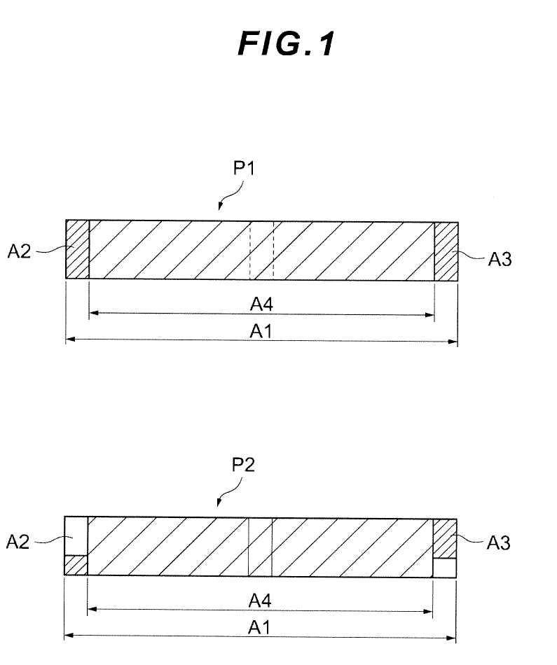

FIG. 1 shows a configuration diagram of packets used in the present invention. In the packet P1, both ends of an entire access area A1 are configured as a head access area A2 and a last access area A3 while the area in between the head access area A2 and the last access area A3 is configured as a middle access area A4.

If a packet P1 is configured of a plurality of access units of data and the access unit, for example, should be 64 B, the head access area A2 and the last access area A3 are respectively configured of 64 B data and, at the same time, the middle access area A4 is configured of data of 64 B * the integer multiple.

Meanwhile, a packet P2 is used in a case where the head access area A2 and the last access area A3 are configured of data smaller than 64 B. For example, if data smaller than 64 B is added to the data of 64 B * the integer multiple, both of the areas of the head access area A2 and the last access area A3 or either one of the areas might be configured of data smaller than 64 B.

The data smaller than 64 B is temporarily stored in the buffer and, if the address of the data of the packet which is input subsequently (data smaller than 64 B) is sequential to the address of the data stored in the buffer, that is, if the addresses of both the data are a hit, the data is combined with the data of the packet which is input subsequently. The combined data is stored in the memory on condition that 64 B data is configured from this data.

For example, if the address of the data smaller than 64 B stored in the buffer and the start address of the head access area A2 in the packet P2 (the start address to identify the head access area A2) are a hit, the data smaller than 64 B in the head access area A2 and the data smaller than 64 B stored in the buffer are combined and subsequently, on condition that the 64 B data is configured, stored in the memory.

Furthermore, if the address of the data smaller than 64 B stored in the buffer and the last address of the data (data smaller than 64 B) of the last access area A3 in the packet P2 (the last address to identify the last access area A3) are a hit, the data smaller than 64 B stored in the buffer and the data in the last access area A3 are combined and subsequently, on condition that 64 B data is configured from this data, this data is stored in the memory.

Specifically speaking, in processing the data smaller than 64 B, an operation in which the data smaller than 64 B and the data read from the memory (hereinafter also referred to as &apos;read data&apos;) are combined and the combined data (hereinafter also referred to as &apos;modified data&apos;) are written to the memory (hereinafter also referred to as &apos;data writing&apos;), that is, the RMW reduction operation is performed.

At this point, the RMW reduction operation (hereinafter, the function of performing the RMW reduction operation is also referred to as the &apos;RMW reduction function&apos;) at least includes the processing of, in processing the data smaller than 64 B, temporarily storing the data smaller than 64 B in the buffer and, on condition that the address of the processing data which becomes the target of the subsequent processing (the data smaller than 64 B) and the address of the data stored in the buffer are a hit, combining (modifying) the data stored in the buffer and the processing data which becomes the target of the subsequent processing (the data smaller than 64 B) and, if the combined data is 64 B, writing the combined data to the memory. Furthermore, the data smaller than 64 B indicates the data outside the specified value for specifying the access unit (64 B).

Next, the overview of the RMW reduction operation is described. It should be noted that the RMW reduction operation described below is performed by a memory control unit (not shown in the figure) which controls the memory.

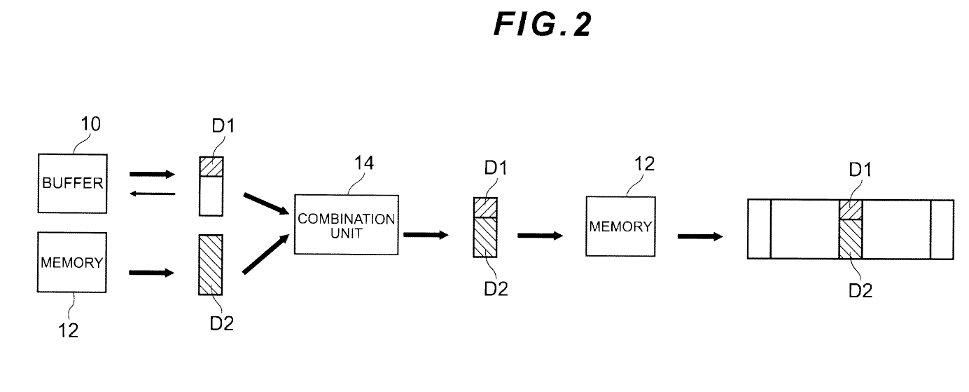

FIG. 2 shows a conceptual diagram in cases where there is a hit in the middle access area during read access.

In FIG. 2, if data D1 smaller than 64 B is stored in a buffer 10, [the memory control unit] reads the data D1 from the buffer 10, and sets the address of the read data D1 to an unused state. Subsequently, [the memory control unit] reads data D2 of the address corresponding to the read data D1 from a memory 12, combines (modifies) the data D1 and D2 in a combination unit (e.g. an RMW control unit in the memory control unit described later) 14 and, if the combined data D1 and D2 is the 64 B data, writes the combined data to the memory 12 as 64 B read data, and configures a packet.

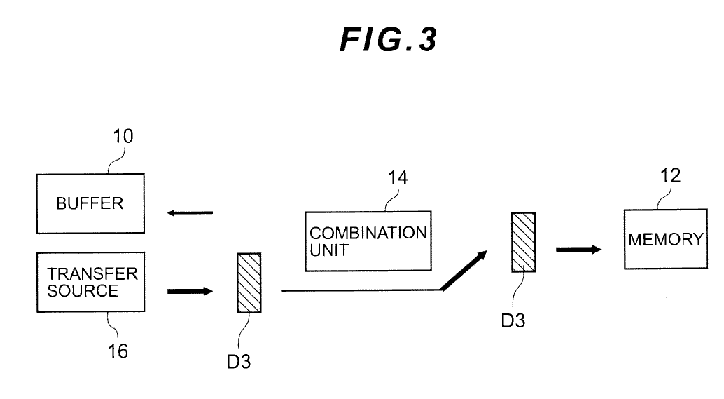

FIG. 3 shows a conceptual diagram in cases where there is a hit in the middle access area during write access.

In FIG. 3, if there is a hit in the middle access area during write access, [the memory control unit] sets the buffer 10 corresponding to the address with the hit to an unused state, and receives 64 B data D3 from a transfer source 16. In this case, as [the memory control unit] processes the 64 B data D3, [the memory control unit] writes the 64 B data D3 directly to the memory 12, and not via the combination unit 14.

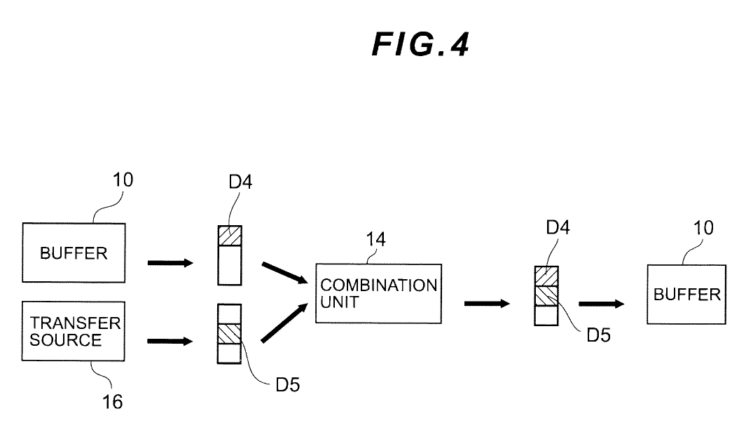

Next, FIG. 4 shows a conceptual diagram in cases where there is a hit in the head access area during write access.

In FIG. 4, if data D4 smaller than 64 B which is stored in the buffer 10 and data D5 smaller than 64 B among the data received from the transfer source (e.g. an access source to be a master described later) 16 are a hit, [the memory control unit] reads the data D4 from the buffer 10, combines the read data D4 and the data D5 from the transfer source 16 in the combination unit 14 and, if the combined data D4 and D5 is smaller than 64 B, stores the combined data D4 and D5 in the buffer 10.

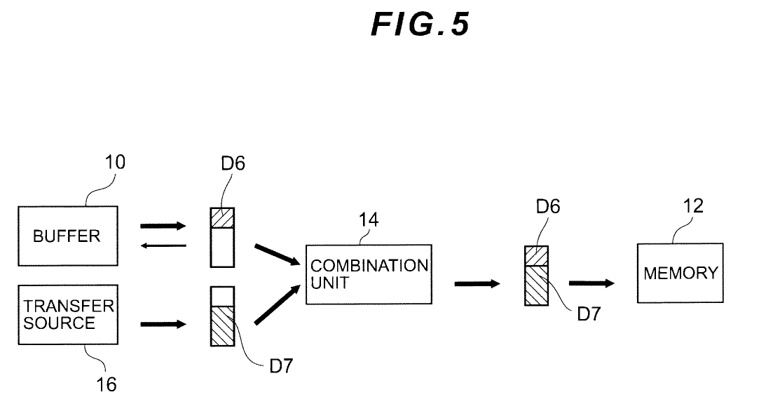

Next, FIG. 5 shows a conceptual diagram in cases where there is a hit in the head access area of the write data.

In FIG. 5, if data D6 stored in the buffer 10 and data D7 smaller than 64 B received from the transfer source 16 are a hit, [the memory control unit] reads the data D6 from the buffer 10, combines the read data D6 and the received data D7 in the combination unit 14 and, if the combined data D6 and D7 is 64 B, writes the combined data D6 and D7 to the memory 12.

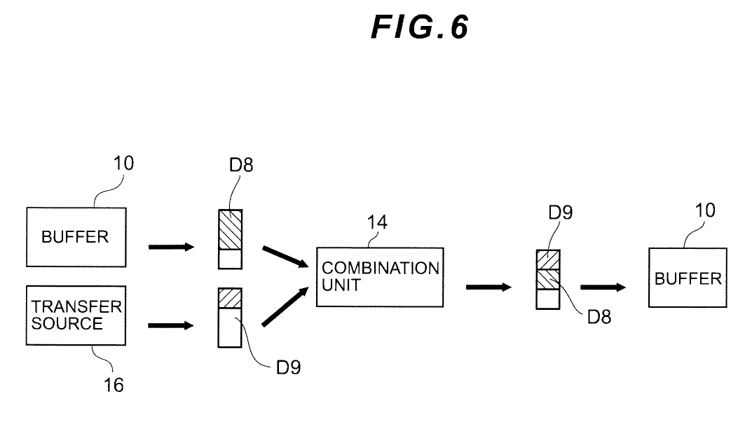

Next, FIG. 6 shows a conceptual diagram in cases where there is a hit in the last access area of the write data.

In FIG. 6, if data D8 stored in the buffer 10 and data D9 smaller than 64 B received from the transfer source 16 are a hit, [the memory control unit] reads the data D8 from the buffer 10, combines the read data D8 and the received data D9 in the combination unit 14 and, if the combined data D8 and D9 is smaller than 64 B, stores the combined data D8 and D9 in the buffer 10 without writing the same to the memory 12.

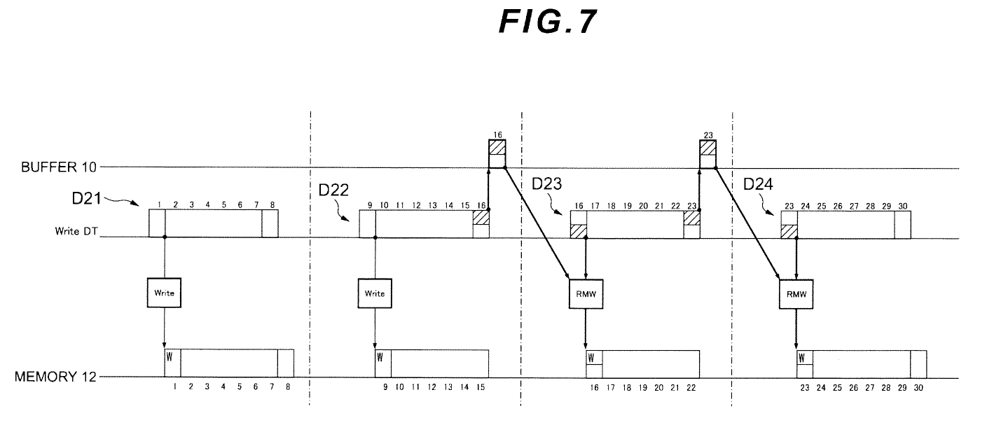

Next, the concrete contents of the RMW reduction operation are explained with reference to FIGS. 7 to 12. It should be noted that each of the RMW reduction operations described below is performed by the memory control unit (not shown in the figure) which controls the memory.

In FIG. 7, if write data D21 is configured of eight data blocks corresponding to the addresses from 1 to 8 and each data block is configured of 64 B, the data of each of the data blocks in the write data D21 is sequentially written to the memory 12 per data block for satisfying the condition of the access unit.

If write data D22 is configured of eight data blocks corresponding to the addresses from 9 to 16 and the data of [each of] the data blocks of the addresses 9 to 15 is 64 B while the data of the data block of the address 16 is smaller than 64 B, the data belonging to the data blocks of the addresses from 9 to 15 is written to the memory 12 as the data by the access unit. Meanwhile, the data smaller than 64 B corresponding to the address 16 is stored in the buffer 10.

If write data D23 is configured of eight data blocks corresponding to the addresses from 16 to 23 and the data of [each of] the data blocks of the addresses 16 and 23 is smaller than 64 B while the data belonging to [each of] the other data blocks is 64 B, the data of the address 16 among the write data D23 is combined with the data of the buffer 10 on condition that the address of the same is a hit with [the address] of the data of the buffer 10. The combined data is written to the memory 12 as the data by the access unit on condition that [the combined data] is 64 B (RMW).

Furthermore, the data smaller than 64 B of the address 23 from the write data D23 is stored in the buffer 10. The data stored in the buffer 10 is combined on condition that [the data] is a hit with the head address 23 of the write data D24 input subsequently. The combined data is written to the memory 12 as the data by the access unit on condition that the [combined data] is 64 B (RMW).

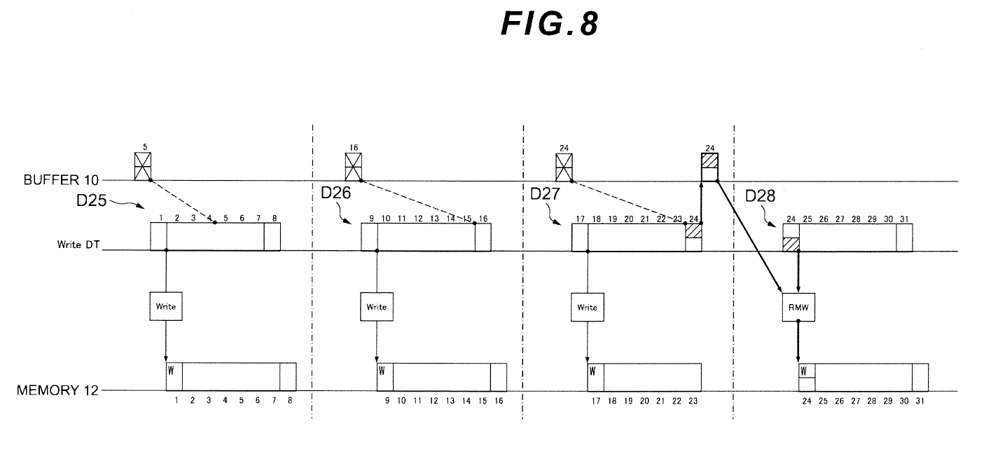

Next, FIG. 8 shows an example in cases where there is a hit with the data of the buffer in the middle access area of the write data,

In FIG. 8, if data of the address 5 from the write data D25 and the data stored in the buffer 10 are a hit, on condition that the data of all the data blocks in the write data D25 is configured of 64 B, the data of each of the data blocks is written directly to the memory 12 while the data of the address 5 existing in the buffer 10 is deleted.

Similarly, if data of the address 16 from the write data D26 and the data stored in the buffer 10 are a hit, on condition that the data of all the data blocks in the write data D26 is configured of 64 B, the data of each of the data blocks is written directly to the memory 12, and the data of the address 16 existing in the buffer 10 is deleted.

Meanwhile, if the last address 24 from write data D27 is a hit with the data stored in the buffer 10 (the data of the address 24), after the data of the buffer 10 is deleted, the data which belongs to the write data D27 and whose address is 24 is stored in the buffer 10. The data of the address 24 stored in the buffer 10 is written to the memory 12 on condition that the head address 24 of the write data D28 and the address of the data stored in the buffer 10 are a hit (RMW).

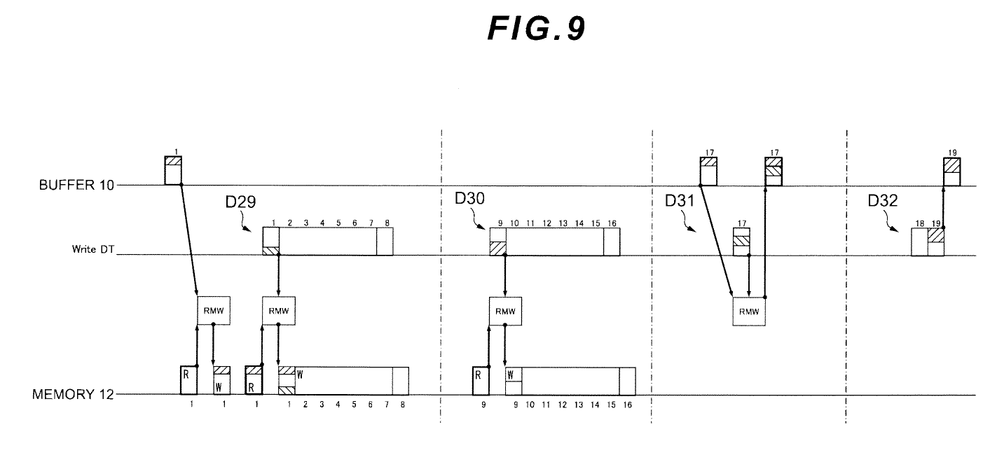

Next, FIG. 9 shows an example where write data and buffer data are not a hit.

In FIG. 9, if write data D29 and the data stored in the buffer 10 are not a hit, the data stored in the buffer 10 and the data stored in the memory 12 are combined, and the combined data is written to the memory 12 (RMW). Subsequently, if the data of the data block corresponding to the head address 1 from the write data D29 is smaller than 64 B, the data of the head address 1 and the data of the address 1 stored in the memory 12 are combined. The combined data is written to the memory 12 on condition that [the combined data] is the data by the 64 B access unit.

Furthermore, if the data of the data block corresponding to the head address 9 from write data D30 is smaller than 64 B and no data exists in the buffer 10, the data of the head address 9 from the write data D30 is combined with the data in the memory 12. The combined data is configured as the data by the 64 B access unit and is written to the memory 12 (RMW).

Furthermore, if write data D31 is configured of the data of the address 17 and this data is smaller than 64 B, the write data D31 is combined with the data stored in the buffer 10 on condition that [the write data D31] is a hit with the data stored in the buffer 10. If the combined data is smaller than 64 B, the combined data is stored in the buffer 10 (RMW).

Furthermore, if the data corresponding to the last address 19 from write data D32 is smaller than 64 B, this data is stored in the buffer 10.

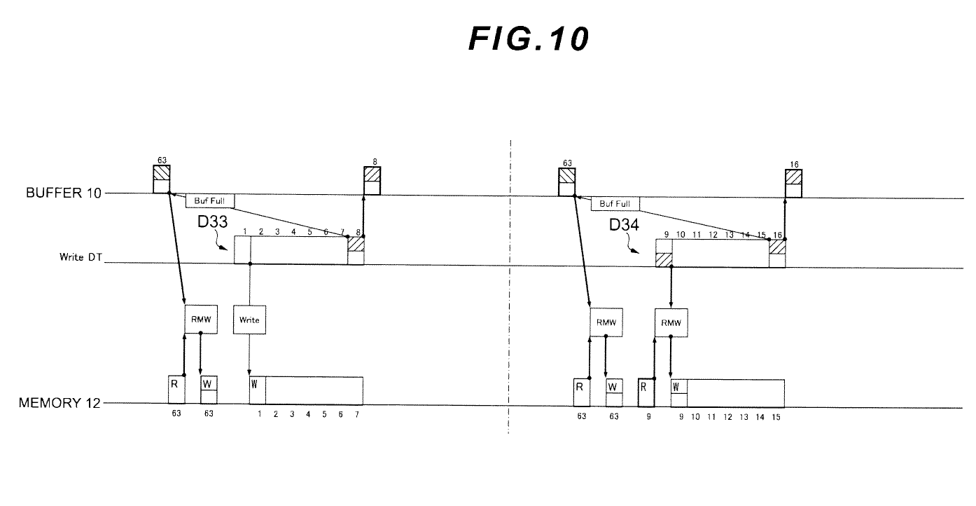

Next, FIG. 10 shows an example in cases where write data and buffer data are not a hit and, at the same time, the buffer is full.

In FIG. 10, if the data of the last address 8 of write data D33 is smaller than 64 B and is not a hit with the data in the buffer 10 and, at the same time, if the buffer 10 is full, before processing the data of the last address 8, [the memory control unit] combines the data stored in the buffer 10 and the data in the memory 12, and writes the combined data in the memory 12 (RMW). Subsequently, [the memory control unit] creates a unused area in the buffer 10, and stores the data of the last address 8 in the unused area of the buffer 10.

Furthermore, if the data of the head address 9 of write data D34 is smaller than 64 B and is not a hit with the data in the buffer 10, [the memory control unit] performs the RMW operation for the data corresponding to the address 9 (RMW).

Meanwhile, if the data of the address 16 of write data D34 is smaller than 64 B and is not a hit with the data stored in the buffer 10 and, at the same time, if the buffer 10 is full, [the memory control unit] performs the RMW operation for the data stored in the buffer 10 (the data of the address 63) (RMW), subsequently creates a unused area in the buffer 10, and stores the data of the address 16 in the unused area of the buffer 10.

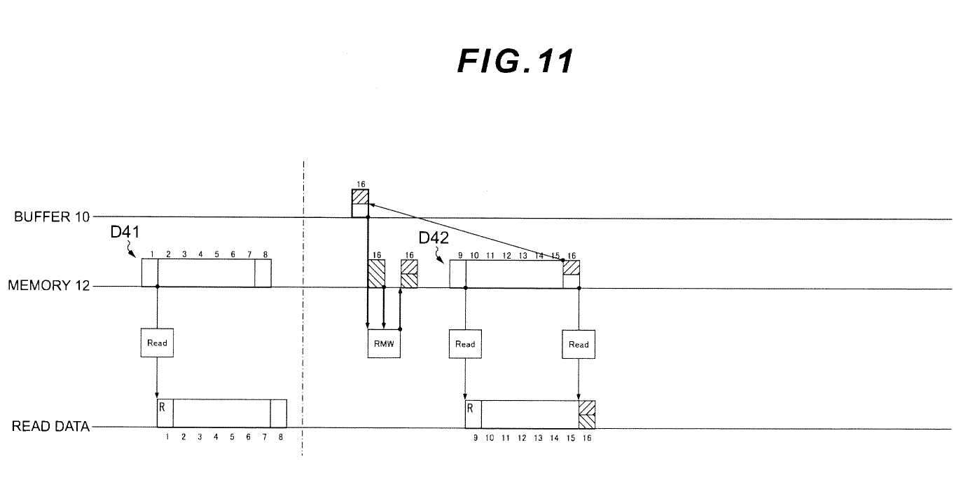

Next, FIG. 11 shows an example of the RMW reduction operation in cases where memory data is processed as read data.

In FIG. 11, if data D41 configured of eight data blocks corresponding to the addresses from 1 to 8 are stored in the memory 12 and the data of each of the data blocks is configured of 64 B, the data of each of the data blocks is sequentially read from the memory 12 as the data by the access unit and is processed as read data.

Furthermore, of data D42 stored in the memory 12, the data of [each of] the data blocks corresponding to the addresses from 9 to 15 is configured of 64 B and the data of [each of] the addresses from 9 to 15 is not a hit with the data stored in the buffer 10, the data of [each of] the data blocks corresponding to the addresses from 9 to 15 is sequentially read from the memory 12 as the data by the access unit and is processed as read data.

Meanwhile, if the data of the address 16 from data D42 is a hit with the data stored in the buffer 10, the latest data stored in the buffer 10 and the data stored in the address 16 of the memory 12 are combined, and the combined data is written to the area of the address 16 in the memory 12 (RMW). Subsequently, the combined data is, on condition that [the combined data] is 64 B, read from the memory 12 as the data by the access unit and is processed as read data. It should be noted that the buffer 10 is subsequently set to the unused state.

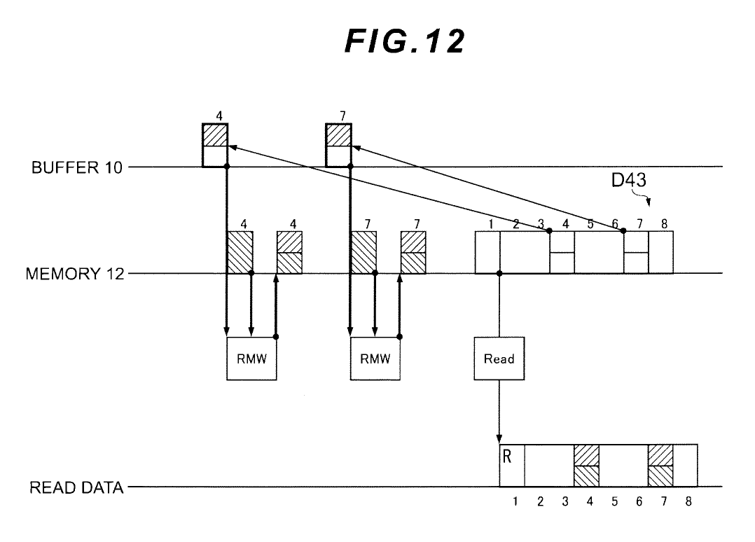

Next, FIG. 12 shows an example of the RMW reduction operation in cases where there are two hits while processing memory data.

In FIG. 12, if, from data D43 stored in the memory 12, the data of [each of] the data blocks corresponding to the addresses 1, 2, 3, 5, 6, and 8 is configured of 64 B and the data of [each of] the data blocks corresponding to the addresses 4 and 7 is configured smaller than 64 B, the data of [each of] the data blocks corresponding to the addresses 1, 2, 3, 5, 6, and 8 is sequentially read from the memory 12 as the data by the access unit and is processed as read data.

Meanwhile, if the data of the addresses 4 and 7 in the data D43 are hits with the data stored in the buffer 10 respectively, the latest data stored in the buffer 10 and the data stored in the addresses 4 and 7 in the memory 12 are combined, and the combined data is written to the areas of the addresses 4 and 7 in the memory 12 respectively (RMW). Subsequently, each of the combined data is read from the memory 12 as data of the access unit on condition that [the combined data] is 64 B, and is processed as read data. It should be noted that the buffer 10 corresponding to the addresses 4 and 7 is set to the unused state after the RMW operation is performed.

### Embodiments

An embodiment of the present invention is described below.

(Overall Configuration)

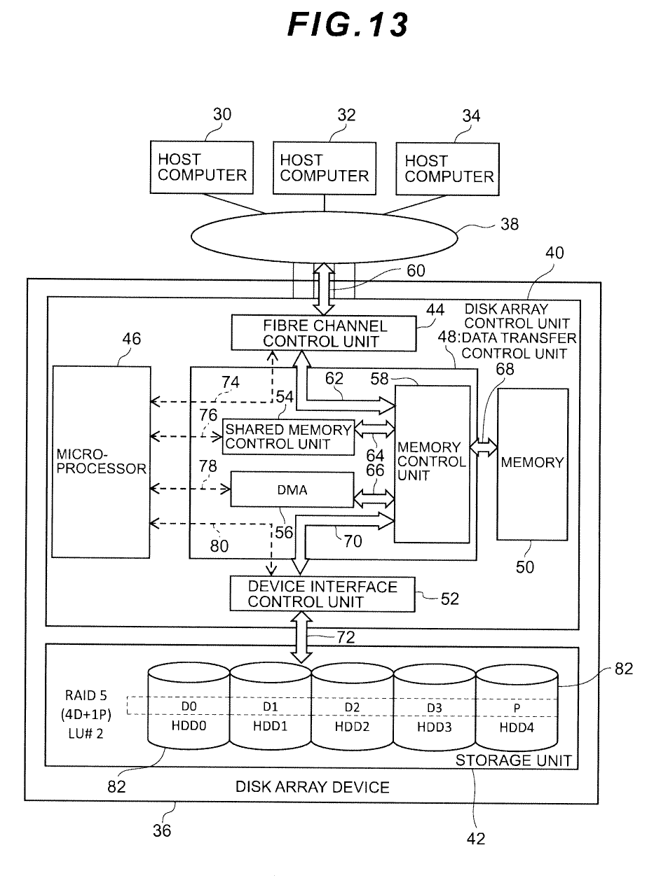

FIG. 13 shows an overall configuration diagram of a computer system to which the present invention is applied. In FIG. 13, the computer system comprises host computers 30, 32, and 34 and a disk array device 36, and the respective host computers 30 to 34 and the disk array device 36 are connected via a network 38.

It should be noted that, as the network 38, for example, FC SAN (Fibre Channel Storage Area Network), IP SAN (Internet Protocol Storage Area Network), LAN (Local Area Network), WAN (Wide Area Network), and others can be used.

The host computers 30, 32, and 34 are computer devices comprising information processing resources, for example, CPUs (Central Processing Units), memories, input/output interfaces, and others, and are configured as, for example, personal computers, workstations, mainframes, and others. The host computers 30 to 34, by issuing access requests including logical units or logical volumes provided from the disk array device 36, for example, write requests (write requests) or read requests (read requests) to the disk array device 36, can access the logical units or the logical volumes.

The disk array device 36 is configured as a storage apparatus or a storage subsystem and is configured of a disk array control unit 40 and a storage unit 42.

The disk array control unit 40 is configured of a Fibre Channel control unit 44, one or more microprocessors 46, a data transfer control unit 48, a memory 50, and a device interface control unit 52 while the data transfer control unit 48 is configured of a shared memory control unit 54, a direct memory access unit (hereinafter also referred to as a DMA (Direct Memory Access)) 56, and a memory control unit 58.

The Fibre Channel control unit 44 is connected to the network 38 via a data bus 60, and is also connected to the memory control unit 58 via a data bus 62. The memory control unit 58 is connected to the shared memory control unit 54 via a data bus 64, connected to the DMA 56 via a data bus 66, connected to the memory 50 via a data bus 68, and connected to the device interface control unit 52 via a data bus 70. The device interface control unit 52 is connected to the storage unit 42 via a data bus 72.

The microprocessor 46 is connected to the memory control unit 58 and the Fibre Channel control unit 44 via a control line 74, connected to the shared memory control unit 54 via a control line 76, connected to the DMA 56 via a control line 78, and connected to the device interface control unit 52 via a control line 80.

The Fibre Channel control unit 44 configures a first interface control unit, transmits and receives information and data to and from the host computers 30 to 34 via the data bus 60 and the network 38, and also transfers the information and data received from the respective host computers 30 to 34 to the memory control unit 58.

The memory control unit 58 performs the processing for writing the data transferred from the Fibre Channel control unit 44 to the memory 50 and also performs the control for transferring the data stored in the memory 50 to the device interface control unit 52.

The device interface control unit 52 configures a second interface control unit for controlling data input/output for the storage unit 42, performs the processing for storing the data read from the memory 50 to the storage unit 42, and also performs the processing for reading the data stored in the storage unit 42 from the storage unit 42 and transferring the same to the memory control unit 58.

The microprocessor 46 performs the integrated control of the entire disk array control unit 40 and, in performing the processing complying with the various types of programs, in accordance with the processing contents of the respective programs, issues control instructions to the respective units via the respective control lines from 74 to 80.

The shared memory control unit 54 transmits and receives data with the memory control unit 58 with reference to control instructions from the microprocessor 46. At this time, the shared memory control unit 54, if a plurality of units of microprocessors 46 are configured, performs the processing for writing the control information shared by the respective microprocessors and the control information for identifying the I/O processing which the respective microprocessors should be in charge of among a plurality of types of I/O (Input/Output) processing in the disk array control unit 40 via the memory control unit 58 to the memory 50.

The DMA 56 transmits and receives data to and from the memory control unit 58 with reference to control instructions from the microprocessor 46. At this time, user data from the host computers 30 to 34 is edited, and the processing for adding parity data and others to the user data is performed.

The storage unit 42 is configured of a plurality of storage devices 82 as storage devices. As respective storage devices 82, for example, HDDs (Hard Disk Drive) can be used.

It should be noted that, as the respective storage devices 82, in substitute for hard disk drives (HDDs), semiconductor memory devices, optical disk devices, magnetic optical disk devices, magnetic tape devices, flexible disk devices, and others can also be used.

If hard disk drives (HDDs) are used as the respective storage devices 82, for example, FC (Fibre Channel) disks, SCSI (Small Computer System Interface) disks, SATA (Serial ATA) disks, ATA (AT Attachment) disks, SAS (Serial Attached SCSI) disks and others can be used.

Furthermore, it is also possible to configure a RAID group, for example, a RAID4, a RAID5, a RAID6, or others, of the respective storage devices 82 or to configure a plurality of RAID groups of the respective storage devices 82. At this time, in the physical storage areas of the respective storage devices 82, a plurality of logical units (hereinafter also referred to as LUs (Logical Units)) and a plurality of logical volumes can also be created.

At this point, if a RAID5 is configured of a plurality of storage devices 82, it is possible to configure a RAID5 of storage devices (HDDs) 82 from #0 to #4 and configure an LU, for example, of #2 in the physical storage area of the storage devices (HDDs) 82 from #0 to #4. In this case, it is possible to use the storage devices (HDDs) 82 from #0 to #3 as the storage devices for storing data from D0 to D3 and use the storage device (HDD) 82 of #4 as the storage device for storing parity data P.

The respective LUs are logical units provided from the disk array device 36 to the respective host computers 30 to 34 and are classified as normal LUs and virtual LUs.

The normal LUs are configured of logical storage areas created in the respective storage devices 82, and are used for managing the respective storage devices 82. Meanwhile, the virtual LUs are logical units provided by the Thin Provisioning function, and are configured of the units of storage areas referred to as pages. The pages of the virtual LUs are not associated with any logical storage area created of a physical storage area before data is written to the virtual LUs. Meanwhile, if virtual LUs become the access target and new data is written to the pages of the virtual LUs, the storage areas which are part of the logical storage areas created in the respective storage devices 82 are assigned to the relevant pages to which [the data] was written, and the data is stored in these assigned storage areas.

To the normal LUs and virtual LUs, LUNs (Logical Unit Numbers) are assigned as identifiers, and logical block addresses LBAs (Logical Block Addresses) are also assigned. At this time, the respective host computers 30 to 34, by transmitting access requests including the LUNs as the identifiers and the logical addresses comprised of the logical block addresses LBAs to the disk array device 36, can access the data stored in the storage areas corresponding to the virtual LUs.

In this case, in the disk array device 36, the processing for making the virtual LUs correspond to the normal LUs by using an LU management table is performed.

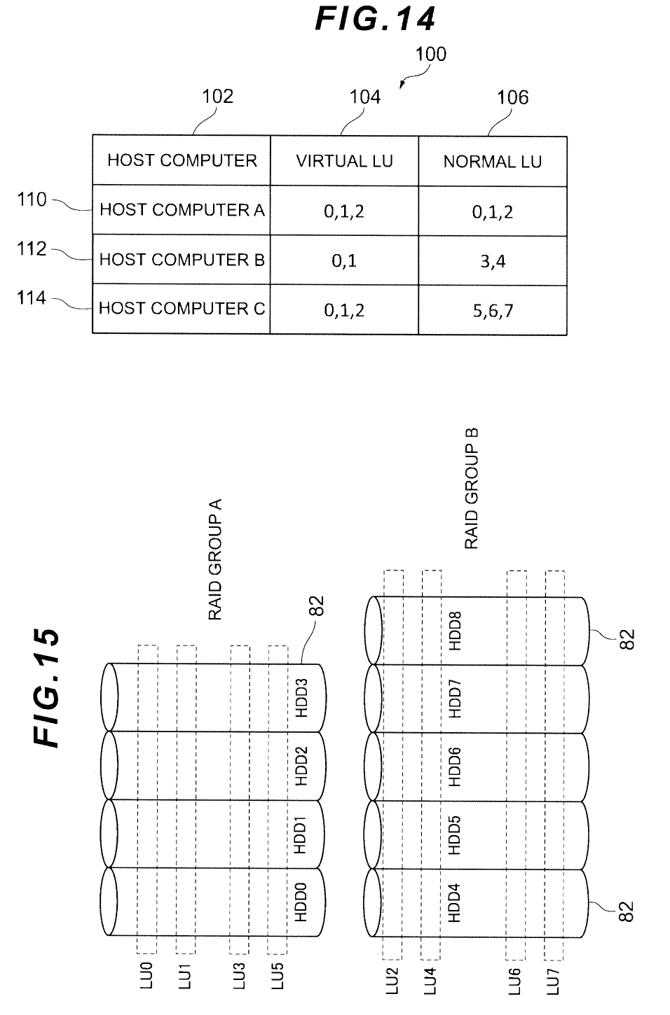

FIG. 14 shows the configuration of the LU management table 100 managed by the microprocessor 46.

The LU management table 100 is a table stored in, for example, the memory 50 or in a memory integrated in the microprocessor 46 (not shown in the figure), and is configured of a host computer field 102, a virtual LU field 104, and a normal LU field 106.

In the respective entries of the host computer field 102, the information related to the names for uniquely identifying the host computers 30, 32, and 34 is stored. For example, the name for uniquely identifying the host computer 30 “Host computer A” is stored in the entry 110, the name for uniquely identifying the host computer 32 “Host computer B” is stored in the entry 112, and the name for uniquely identifying the host computer 34 “Host computer C” is stored in the entry 114.

In the respective entries of the virtual LU field 104, the information of the identifiers for identifying the virtual LUs provided to the respective host computers 30 to 34 is stored. For example, “0,” “1,” and “2” are stored in the entry 110 as the numbers of the virtual LUs provided to the host computer 30, “0” and “1” are stored in the entry 112 as the numbers of the virtual LUs provided to the host computer 32, and “0,” “1,” and “2” are stored in the entry 114 as the numbers of the virtual LUs provided to the host computer 34.

In the respective entries of the normal LU field 106, the information related to the identifiers of the normal LUs corresponding to the respective virtual LUs is stored. For example, “0,” “1,” and “2” are stored in the entry 110 as the normal LU numbers corresponding to the virtual LUs, “3” and “4” are stored in the entry 112 as the normal LU numbers corresponding to the virtual LUs, and “5,” “6,” and “7” are stored in the entry 114 as the normal LU numbers corresponding to the virtual LUs.

At this time, the microprocessor 46, if receiving the information related to the virtual LUs from the host computer 30, performs the processing for making the virtual LUs “0,” “1,” and “2” correspond to the normal LUs “0,” “1,” and “2.” Similarly, if receiving the information related to the virtual LUs from the host computer 32, [the microprocessor 46] performs the processing for making the virtual LUs “0” and “1” correspond to the normal LUs “3” and “4.” Similarly, if receiving the information related to the virtual LUs from the host computer 34, [the microprocessor 46] performs the processing for making the virtual LUs “0,” “1,” and “2” correspond to the normal LUs “5,” “6,” and “7.”

FIG. 15 shows a configuration diagram of normal LUs. In FIG. 15, for configuring the normal LUs, for example, if a RAID group A is configured of a plurality of storage devices 82, an LU0, an LU1, an LU3, and an LU5 can be configured in the physical storage areas from #0 to #3 of storage devices 82. Furthermore, if a RAID group B is configured of storage devices 82 from #4 to #8, an LU2, an LU4, an LU6, and an LU7 can be configured in the physical storage areas of storage devices 82 from #4 to #8.

At this time, among the LUs belonging to the RAID group A, the LU0, the LU1 and among the LUs belonging to the RAID group B, the LU2, are processed as the access target of the host computer 30. The LU3 belonging to the RAID group A and the LU4 belonging to the RAID group B are processed as the access target of the host computer 32. The LU5 belonging to the RAID group A and the LU6 and the LU7 belonging to the RAID group B are processed as the access target of the host computer 34.

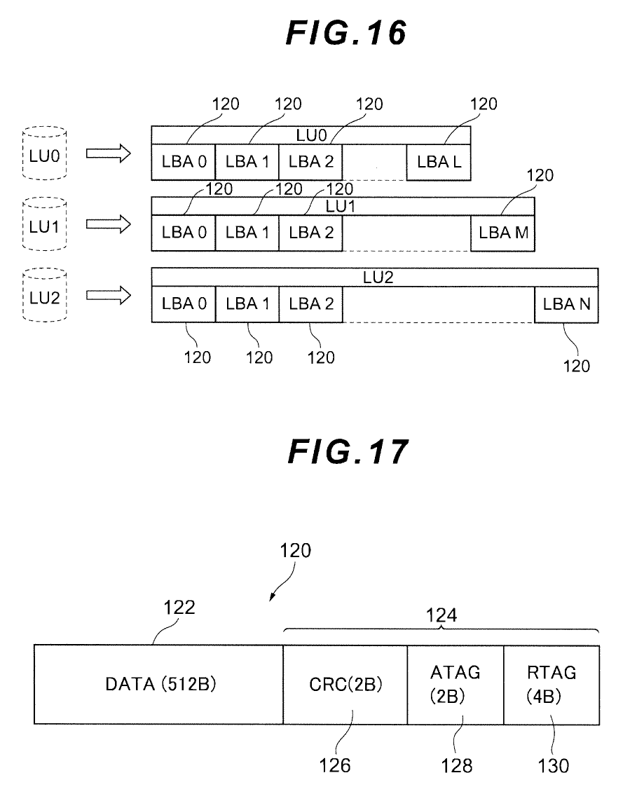

Next, FIG. 16 shows a block configuration diagram of the normal LUs.

In FIG. 16, a normal LU is configured of a plurality of sub-blocks and, to the respective sub-blocks, the sequential addresses are assigned sequentially from the head. For example, if a normal LU0 is configured of sub-blocks 120 from #0 to #L, to the sub-blocks 120 from #0 to #L, as the sequential addresses, an LBA 0, an LBA 1, an LBA 2, . . . , and an LBA L are assigned. Similarly, if a normal LU1 is configured of sub-blocks 120 from #0 to #M, to the sub-blocks from #0 to #M, as the sequential addresses, an LBA 0, an LBA 1, an LBA 2, . . . , and an LBA M are assigned. Furthermore, if a normal LU2 is configured of sub-blocks 120 from #0 to #N, to the sub-blocks 120 from #0 to #N, as the sequential addresses, an LBA 0, an LBA 1, an LBA 2, . . . , and an LBA N are assigned. It should be noted that 520 B data is stored in each sub-block.

Next, FIG. 17 shows a configuration diagram of a sub-block. In FIG. 17, a sub-block 120 is configured of 512 B data 122 and an 8 B data guarantee code 124. The data guarantee code 124 is configured of a 2 B guarantee code (CRC) 126, a 2 B LUN information (ATAG) 128, and a 4 B LBA information (RTAG) 130. The data guarantee code 124 is added to the data 122 as the code to guarantee the storage position of the data 122.

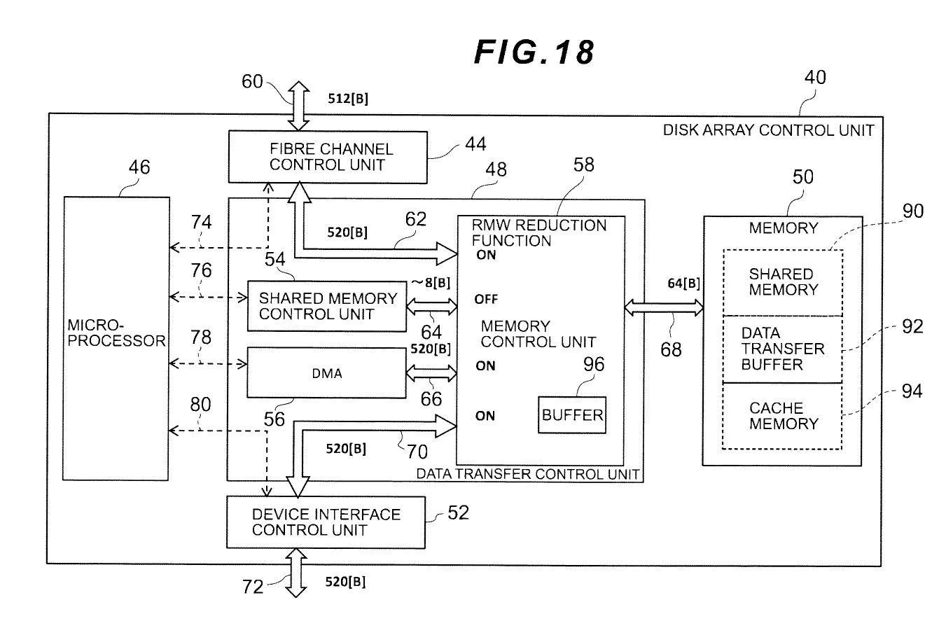

Next, FIG. 18 shows a block configuration diagram explaining the relationship between the memory and the data transfer control unit in the disk array control unit.

In FIG. 18, the disk array control unit 40 is configured of a Fibre Channel control unit 44, one or more microprocessors 46, a data transfer control unit 48, a memory 50, and a device interface control unit 52 while the data transfer control unit 48 is configured of a shared memory control unit 54, a direct memory access unit (DMA (Direct Memory Access)) 56, and a memory control unit 58.

The memory 50 comprises a plurality of storage areas, and each of the storage areas is, as well as being configured as a shared memory 90, configured as a data transfer buffer 92, and further configured as a cache memory 94. In the memory control unit 58, a buffer 96 for temporarily storing data smaller than 64 B is integrated. It should be noted that the buffer 96 can also be allocated in a different position from the memory control unit 58 in the disk array control unit 40.

The shared memory 90 is configured as a control area (shared storage area). In the shared memory 90, if a plurality of microprocessors 46 are configured, the control information shared by the respective microprocessors, the control information for identifying the I/O processing which the respective microprocessors should be in charge of among a plurality of types of I/O (Input/Output) processing in the disk array control unit 40, and others are stored.

The data transfer buffer 92, as well as the cache memory 94, configures a data area (data storage area). In the data transfer buffer 92, the data transferred from the host computers 30 to 34 is stored via the Fibre Channel control unit 44 and the memory control unit 58 in the status of being converted into 64 B data. The data stored in the data transfer buffer 92 is transferred to the cache memory 94 by the control of the memory control unit 58. In the cache memory 94, the data by the access of the memory control unit 58, that is, 64 B data by the access unit is temporarily stored.

The Fibre Channel control unit 44, if receiving 512 B data from the host computers 30 to 34 as user data, adds an 8 B data guarantee code to the received user data, and transfers the 520 B data including the user data and the data guarantee code to the memory control unit 58.

The memory control unit 58, for transmitting and receiving the 520 B data to and from the Fibre Channel control unit 44, if the master indicating the access source is the Fibre Channel control unit 44, considering that the RMW reduction function (the function of performing the RMW reduction operation) is on, performs the RMW reduction operation.

Furthermore, the memory control unit 58, for transmitting and receiving the 520 B data to and from the DMA 56, if the master indicating the access source is the DMA 56, considering that the RMW reduction function is on, performs the RMW reduction operation.

Similarly, the memory control unit 58, for transmitting and receiving the 520 B data to and from the device interface control unit, if the master indicating the access source is the device interface control unit 52, considering that the RMW reduction function is on, performs the RMW reduction operation.

In this case, the memory control unit 58, for transmitting and receiving the 520 B data to and from the part where RMW reduction function is on, splits the 520 B data into 64 B data which is the access unit during accessing the memory 50 and, if the data acquired by splitting is write data, writes the 64 B data of the write data to the cache memory 94 in the memory 50, and temporarily stores the write data smaller than 64 B in the buffer 96. Subsequently, for processing the data stored in the buffer 96, the memory control unit 58 performs the RMW reduction operation.

Specifically speaking, in process of processing the 520 B data, it is likely that the addresses of the processing data which is currently processed and the subsequent processing data to be processed whereafter are sequential. Therefore, if data smaller than 64 B, write data for example, occurs from the data to be processed, [the memory control unit] temporarily stores the write data smaller than 64 B in the buffer 96, if the write data temporarily stored in the buffer 96 and the subsequent processing data (write data smaller than 64 B) are a hit (if the addresses of the data of both of the same are sequential or if the addresses of the data of both of the same are identical), combines the write data smaller than 64 B which is temporarily stored in the buffer 96 and the subsequent processing data (write data smaller than 64 B) and, on condition that the combined data is 64 B data, performs the RMW reduction operation of writing the combined data to the cache memory 94.

Meanwhile, as for the data processed between the memory control unit 58 and the shared memory control unit 54 (for example, 8 B data), the addresses of the processing data which is currently processed (processing data) and the subsequent processing data to be processed whereafter are not sequential. Specifically speaking, no hit occurs in the addresses of the data transmitted and received between the memory control unit 58 and the shared memory control unit 54.

Therefore, the memory control unit 58, for transmitting and receiving data to and from the shared memory control unit 54, if the master indicating the access source is the shared memory control unit 54, considering that the RMW reduction function is off, performs the RMW operation.

For example, the memory control unit 58 reads data (64 B data) from the shared memory 90 with reference to the address of the data to be processed (8 B data), generates 64 B data by combining the read data (64 B data) and the data to be processed (8 B data), and performs the processing of writing the generated data (the updated 64 B modified data generated by updating the read data by the data to be processed) to the shared memory 90 as the RMW operation.

For transmitting and receiving data between the memory control unit 58 and the shared memory control unit 54, by excluding the operation accompanied by this data transmission/reception from the target of the RMW reduction operation, the size of the buffer 96 can be inhibited from increasing.

Furthermore, the memory control unit 58 performs the RMW operation or the RMW reduction operation for transmitting and receiving data to and from the memory 50, in accordance with the access destination (data write destination or data read destination).

For example, the memory control unit 58 performs the RMW operation for transmitting and receiving 64 B data to and from the shared memory 90 in the memory 50, if the access destination is the shared memory 90, considering that the RMW reduction function is off.

For transmitting and receiving data between the memory control unit 58 and the shared memory 90, by excluding the operation accompanied by this data transmission/reception from the target of the RMW reduction operation, the size of the buffer 96 can be inhibited from increasing.

Meanwhile, the memory control unit 58 performs the RMW reduction operation for transmitting and receiving 64 B data to and from the data transfer buffer 92 or the cache memory 94 in the memory 50, if the access destination (data write destination) is the data transfer buffer 92 or the cache memory 94, considering that the RMW reduction function is on.

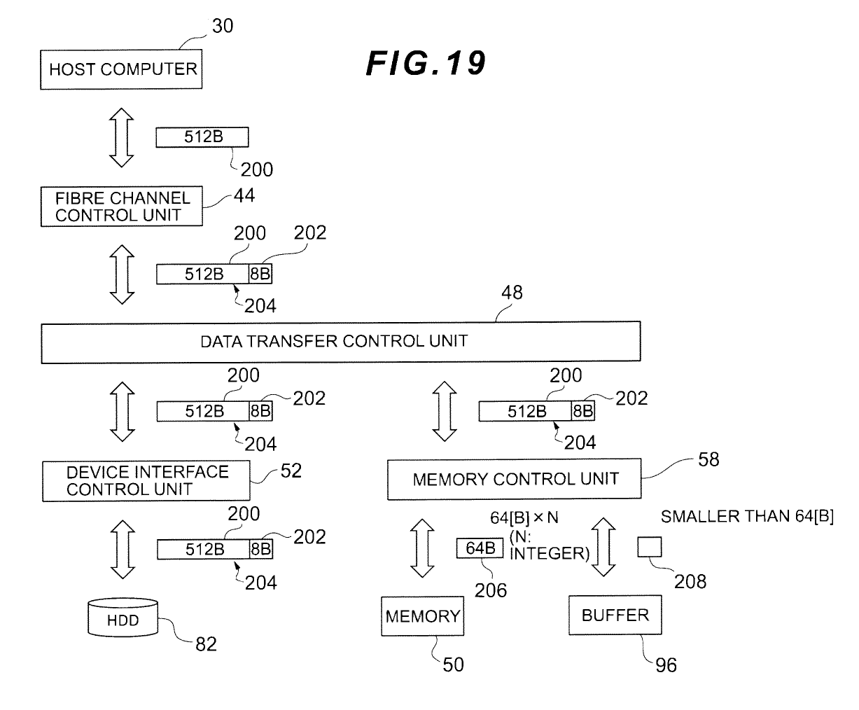

FIG. 19 shows a pattern diagram explaining the flow of data processing in the disk array device.

In FIG. 19, if the Fibre Channel control unit 44 receives 512 B user data 200 as the user data transmitted from the host computer 30, the Fibre Channel control unit 44 adds an 8 B data protection code 202 to the 512 B user data 200, and generates 520 B data 204. The generated 520 B data 204 is transferred to the device interface control unit 52 and the memory control unit 58 in the data transfer control unit 48. The device interface control unit 52 performs the read access or write access for the storage devices 82 with the 520 B data 204 as the access unit.

Meanwhile, the memory control unit 58 splits the 520 B data 204 into data 206 by the 64 B access unit, writes the 64 B data 206 to the memory 50, writes the data 208 smaller than 64 B to the buffer 96, and performs the RMW reduction operation for the data 208 stored in the buffer 96.

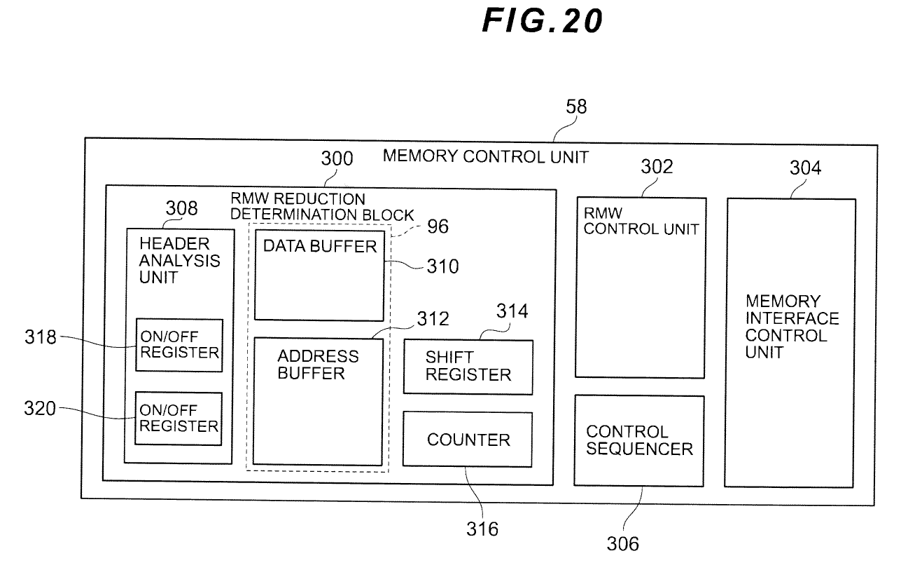

Next, FIG. 20 shows a block diagram of the memory control unit.

In FIG. 20, the memory control unit 58 is configured of an RMW reduction determination block 300 for performing header analysis and buffer management, an RMW control unit 302 for controlling the RMW operation, a memory interface control unit 304 for performing access control for the memory 50, and a control sequencer 306 for controlling the processing by the memory interface control unit 304.

The RMW reduction determination block 300 is configured of a header analysis unit 308, a data buffer 310, an address buffer 312, a shift register 314, and a counter 316.

The data buffer 310 and the address buffer 312 configure the buffer 96 integrated in the memory control unit 58, and the storage area of the data buffer 310 is split into a plurality of blocks, to each block of which data smaller than 64 B is stored. The storage area of the address buffer 312 is split into a plurality of blocks, in each block of which the address for managing the data stored in each of the blocks in the data buffer 310 is stored.

In the shift register 314, the information related to the oldest data of the data stored in the data buffer 310 is stored. The counter 316 starts at the point of time data smaller than 64 B is stored in the data buffer 310, and functions as a timer for measuring the elapsed time as a timer value.

The header analysis unit 308 analyzes whether to perform the RMW reduction operation or not in accordance with the master identifier and the destination address of the header information added to the packet. In this header analysis unit 308, an on/off register 318 and an on/off register 320 are integrated.

Specifically speaking, the header analysis unit 308, as for a plurality of masters indicating the access source of the processing data to be processed during access, determines whether [the masters are] the masters within the target for which a specific operation (RMW reduction operation) is performed or the masters which are outside the target for which the specific operation is performed and, in accordance with this determination result, performs the processing for performing the RMW reduction operation or the RMW operation.

For example, the header analysis unit 308 sets the RMW reduction operation to off for performing the RMW operation for processing the data of any of the Fibre Channel control unit 44, the DMA 56, or the device interface control unit 52, considering that the master is the master within the target, sets the RMW reduction operation to on or, for processing the data in the shared memory control unit 54, considering that the master is the master outside the target.

Furthermore, the header analysis unit 308 determines the write destination of the data to be the processing target and, if the write destination of the data to be the processing target is a specific write destination of the memory 50, the cache memory 94 or the data transfer buffer 92 for example, sets the RMW reduction operation to on or, if the write destination of the data to be the processing target is different from the specific write destination of the memory 50, the shared memory 90 for example, sets the RMW reduction operation to off.

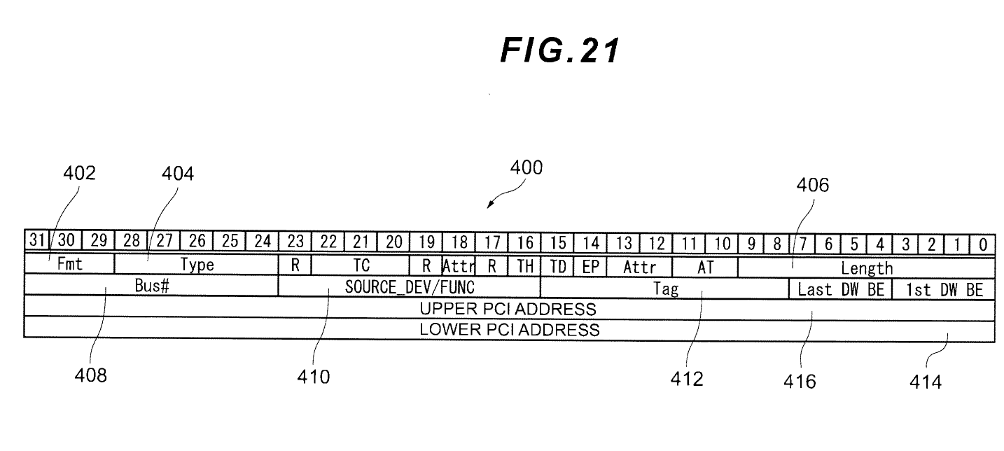

Next, FIG. 21 shows a configuration diagram of header information. In FIG. 21, the header information 400 is configured of information of bits from 0 to 31, and the information related to read access or write access is stored as an access type in a format (Fmt) 402 and a type (Type) 404. In a length (Length) 406, the information related to the data transfer length is stored. In a bus number (Bus#) 408, the information of an identification number to identify the access source is stored and, in a source device (SOUCE DEV) 410, the information for identifying the access source, that is, the master is stored. In a tag 412, tag information is stored.

In a lower PCI address 414, the information related to the address of bits from 0 to 31 as PCI addresses is stored while, in the upper PCI address 416, the information related to the address of bits from 32 to 63 as PCI addresses is stored.

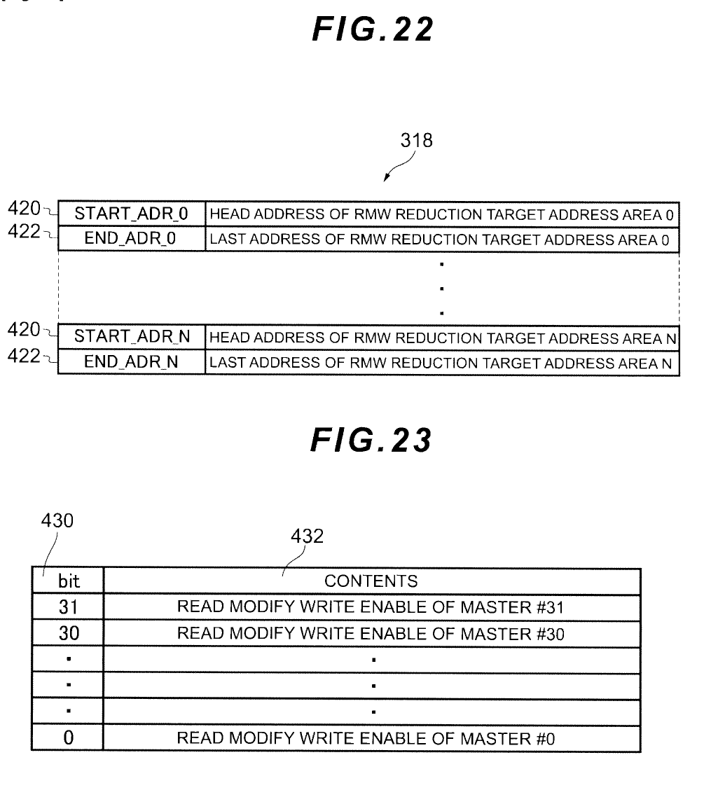

Next, FIG. 22 shows a configuration diagram of an on/off register sorted by address.

In FIG. 22, the on/off register 318 sorted by address is configured of start addresses 420 from #0 to #N and end addresses 422 from #0 to #N. In each of the start addresses 420, the information related to the head address of the RMW reduction target address area is stored and, in each of the end addresses 422, the information related to the last address of the RMW reduction target address area is stored

Specifically speaking, for the memory control unit 58 to determine whether to perform the RMW reduction operation or not by the destination address, the information related to the range of destination addresses to be the data write destination is stored in the on/off register 318.

Next, FIG. 23 shows a configuration diagram of an on/off register 320 sorted by master. In FIG. 23, the on/off register 320 comprises bits 430 from 0 to 31, in each bit 430 of which, as the information corresponding to the masters (access source) from #0 to #31, the information “1” or “0” indicating the RMW enable information is stored.

In this case, the case of enable=1 indicates that the RMW reduction function is on while the case of enable=0 indicates that the RMW reduction function is off.

For example, if the master #0 is the DMA 56, the information of enable=1 is stored in the contents 432 of the bit 430 #0. Furthermore, if the master #30 is the shared memory control unit 54, the information of enable=0 is stored in the contents 432 of the bit 430 #30.

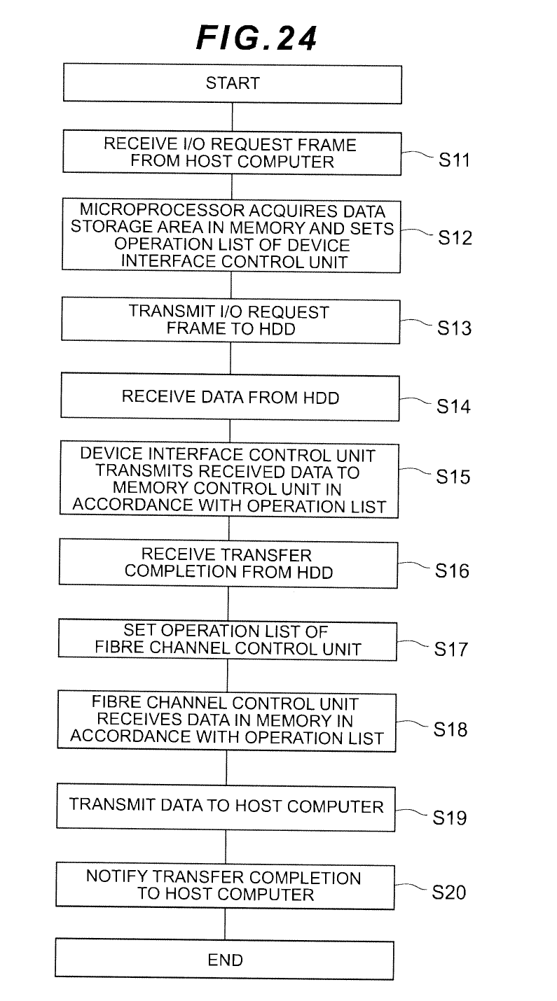

Next, the read processing of the disk array device 36 is explained with reference to the flowchart of FIG. 24. This processing is started along with the issuance of a read command issued from any of the host computers 30 to 34, the host computer 30 for example.

The host computer 30, for issuing a read command, adds a read command specifying a virtual LUN, an LBA, and a RAID group to the I/O request frame.

If the Fibre Channel control unit 44 receives the I/O request frame issued by the host computer 30 (S11), the Fibre Channel control unit 44 notifies the microprocessor 46 of the reception of the I/O request frame.

Next, the microprocessor 46, when receiving the I/O request frame, as well as performing the processing for acquiring an area for storing the data in the memory 50, sets an operation list including the information of the read data storage destination memory addresses, LUs (normal LUs), LBAs, and others as an operation list of the device interface control unit 52 (S12). The device interface control unit 52 starts the processing for reading the read data from the storage devices 82 with reference to the information of the LUs (normal LUs) and the LBAs in the operation list.

Firstly, the device interface control unit 52 transmits the I/O request frame to the storage devices (HDDs) 82 in the storage unit 42 (S13), and receives the read data from the storage devices 82 (S14).

Next, the device interface control unit 52, in accordance with the operation list set at step S12, transfers the information for writing the received read data to the specified memory 50 to the memory control unit 58 (S15). By this method, the memory control unit 58 makes write access to the memory 50 in accordance with the received information, and writes the read data to the cache memory 94. In this case, the memory control unit 58 performs the RMW reduction operation in process of making write access to the memory 50.

Next, the device interface control unit 52, when receiving a transfer completion [notification] from the storage devices (HDDs) 82, notifies what is received to the microprocessor 46 (S16).

Next, the microprocessor 46 sets an operation list of the Fibre Channel control unit 44 (S17).

Next, the Fibre Channel control unit 44, in accordance with the operation list set at step S17, deletes the 8 B data guarantee code 154 from the read data transferred from the memory control unit 58, and processes the data (512 B data) in which the 8 B data guarantee code 154 is deleted from the 520 B read data as the user data (S18).

At this time, the memory control unit 58 performs the read processing of reading the read data from the cache memory 94 of the memory 50, and transfers the 520 B read data to the Fibre Channel control unit 44.

Next, the Fibre Channel control unit 44 transmits the 512 B user data to the host computer 30 (S19) and, when completing the transmission of all the user data, notifies the transfer completion to the host computer 30 (S20), and ends the processing of this routine.

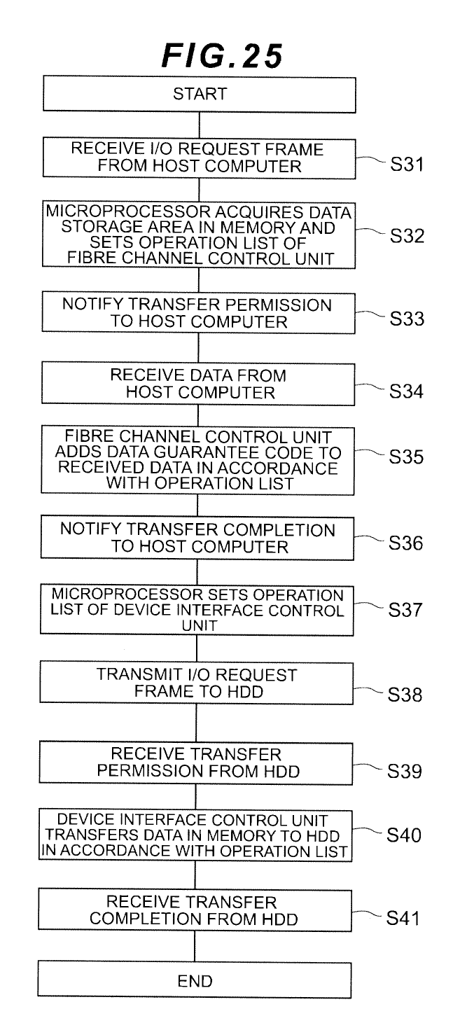

Next, the write processing of the disk array device 36 is explained with reference to the flowchart of FIG. 25. This processing is started as an I/O request frame including a write command is issued from any of the host computers 30 to 34, the host computer 30 for example.

The host computer 30, for issuing a write command, adds a write command specifying a virtual LUN, an LBA, and a RAID group to the I/O request frame.

If the Fibre Channel control unit 44 receives the I/O request frame issued by the host computer 30 (S31), the Fibre Channel control unit 44 notifies the microprocessor 46 of the reception of the I/O request frame.

Next, the microprocessor 46, when receiving the I/O request frame, as well as performing the processing for acquiring an area for storing the data in the memory 50, sets an operation list including the information of the received data storage destination memory addresses, LUs (normal LUs), LBAs, and others as an operation list of the Fibre Channel control unit 44, and further sets an 8 B data guarantee code 154 (S32).

The Fibre Channel control unit 44 notifies the transfer permission to the host computer 30 (S33), and receives user data from the host computer 30 (S34).

Next, the Fibre Channel control unit 44, in accordance with the operation list set at step S32, transfers the information for writing the received user data to the specified memory 50 to the memory control unit 58 (S35).

At this time, the Fibre Channel control unit 44 generates 520 B write data by adding an 8 B data guarantee code 154 to the received data (512 B user data), and also starts the processing for writing the write data to the storage devices 82 with reference to the information of the LUs (normal LUs) and the LBAs in the operation list.

The memory control unit 58 makes write access to the memory 50 with reference to the received information, and writes the write data to the cache memory 94. In this case, the memory control unit 58 performs the RMW reduction operation in process of making write access to the memory 50.

Next, the Fibre Channel control unit 44, as well as notifying the transfer completion to the host computer 30, notifies the transfer completion to the microprocessor 46 (S36).

Next, the microprocessor 46 sets an operation list of the device interface control unit 52 (S37).

Next, the device interface control unit 52, with reference to the operation list, transmits an I/O request frame to the storage devices (HDDs) 82 (S38), and subsequently receives a transfer permission from the storage devices (HDDs) 82 (S39).

Next, the device interface control unit 52, in accordance with the operation list set at step S37, transmits the write data read from the memory 50 to the storage devices 82 (S40). In this case, the memory control unit 58 performs the read processing for the memory 50 at this timing, and transfers the data read from the cache memory 94 as write data to the Fibre Channel control unit 44.

Next, the device interface control unit 52, if receiving the transfer completion [notification] from the storage devices 82, notifies the transfer completion of the write data to the microprocessor 46 (S41), and ends the processing of this routine.

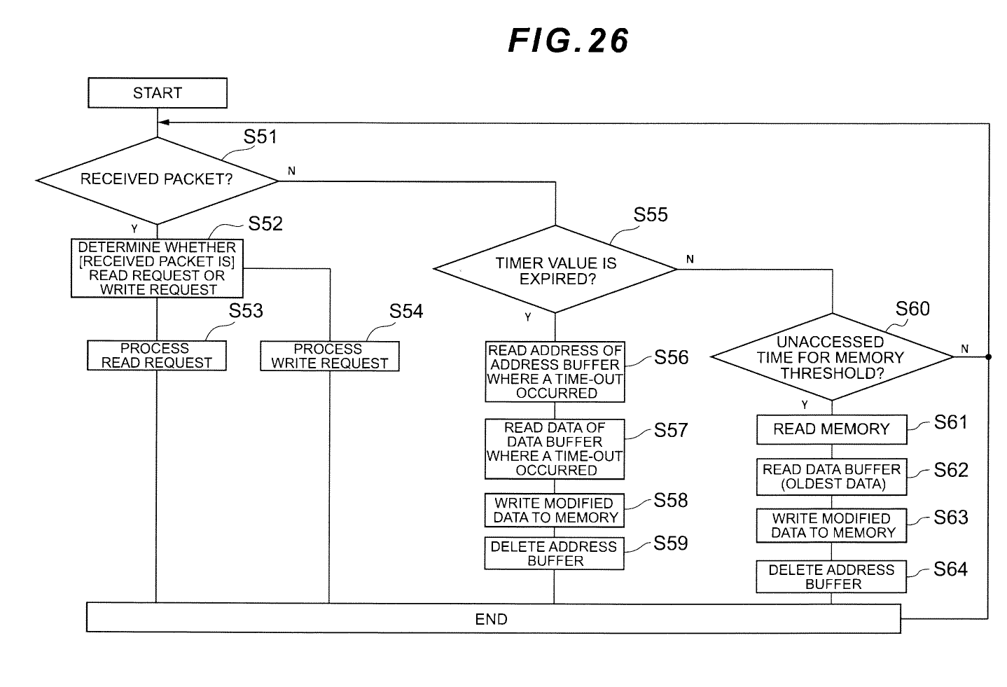

Next, the transfer processing of buffer data is explained with reference to the flowchart in FIG. 26. This processing includes the buffer data transfer processing based on the timer value of the counter and the buffer data transfer processing based on the access time to the memory.

First, the memory control unit 58 determines whether [the memory control unit 58] received a packet from the master or not (S51), if determining that a packet was received, determines whether the I/O request added to the packet is a read request or a write request (S52), performs the processing for the read request (read processing) if [the request is] a read request (S53) or performs the processing by the write request (write processing) if [the request is] a write request (S54), and ends the processing of this routine.

Meanwhile, at step S51, if determining that no packet was received, the memory control unit 58 determines whether the timer value of the counter 316 whose measurement target is the data buffer 310 in which data smaller than 64 B is stored and the address buffer 312 corresponding to this data buffer 310 is expired or not (S55) and, if determining that the timer value of the counter 316 is expired, that is, if the timer value of the counter 316 reached the set value, reads the address of the address buffer 312 where a timeout occurred (S56).

Subsequently, the memory control unit 58 reads the data of the data buffer 310 where the timeout occurred with reference to the read address (S57), writes the read data to the memory 50 as the 64 B modified data (S58), deletes the address buffer of which the timeout was determined (S59), and ends the processing of this routine.

Meanwhile, if determining at step S55 that the time value is not expired, the memory control unit 58 determines whether the unaccessed time for the memory 50 exceeded the threshold or not (S60).

At step S60, if determining that the unaccessed time for the memory 50 exceeded the threshold, the memory control unit 58 considers that no access is made to the memory 50 for more than a certain period of time, reads the data from the memory 50 (S61), reads the oldest data (the data which is the oldest) from the data buffer 310 (S62), generates 64 B modified data (read data or write data) by combining the data read from the memory 50 and the oldest data read from the data buffer 310, writes the generated modified data to the memory 50 (S63), deletes the address buffer 312 corresponding to the data buffer 310 in which the oldest data is stored (S64), and ends the processing of this routine.

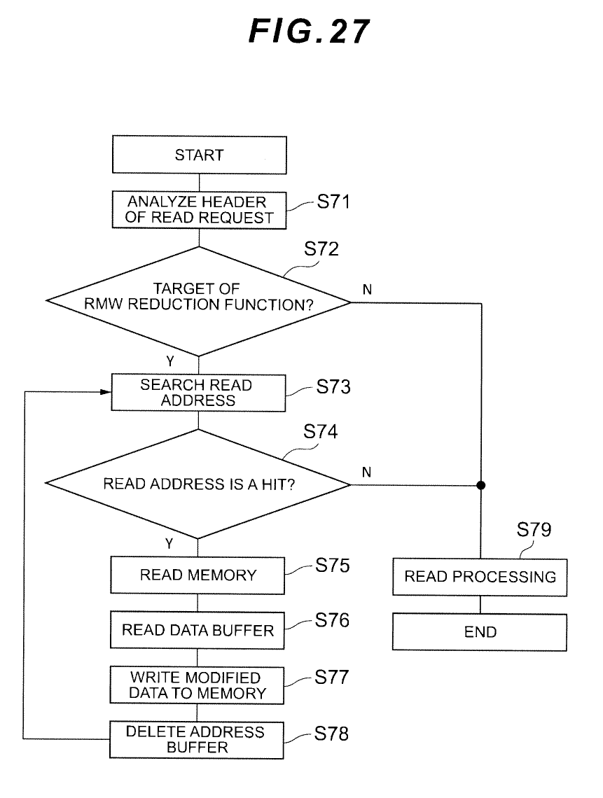

Next, the read processing by the memory control unit 58 is explained with reference to the flowchart in FIG. 27. This processing is the concrete contents of step S53 in FIG. 26.

First, the memory control unit 58 analyzes the header information of the read request, determines the master, that is, determines the access source (S71) and, from this determination result, determines whether the access source is the target of the RMW reduction function or not (S72).

For example, the memory control unit 58 refers to the on/off register 320, if the RMW enable is “1,” determines that the access source is the target of the RMW reduction operation, searches the address buffer 312 with reference to the search target address (S73), and determines whether the search target read address exists in the address buffer 312 or not, that is, whether the read address is a hit or not (S74).

Next, the memory control unit 58, if determining that the read address is a hit, reads the data corresponding to the read address from the memory 50 (S75), reads the data corresponding to the read address from the data buffer 310 (S76), generates 64 B modified data by combining the data read from the memory 50 and the data read from the data buffer 310, writes the generated modified data to the memory 50 (S77), deletes the address buffer 312 corresponding to the read address (S78), and returns to the processing at step S73.

Meanwhile, if determining at step S72 that [the access source] is not the target of the RMW reduction function, that is, if determining that the RMW enable is equal to 0 in the on/off register 320, or if determining at step S74 that the read address is not a hit, the memory control unit 58 performs the processing for reading the data from the memory 50 in accordance with the read address (S79), and ends the processing of this routine.

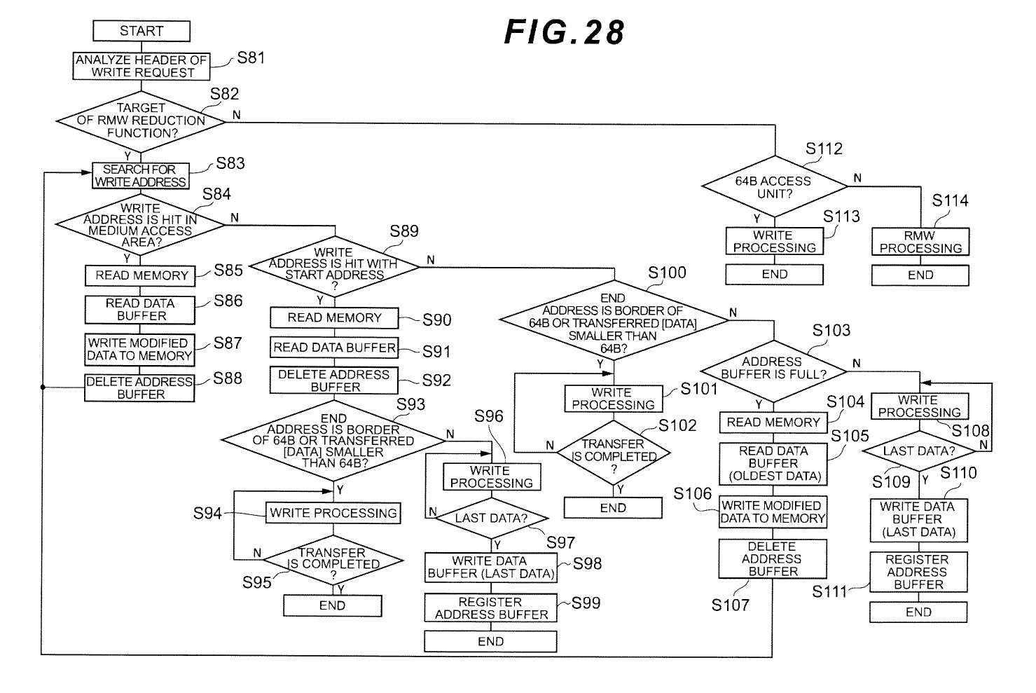

Next, the write processing by the memory control unit is explained with reference to the flowchart in FIG. 28. This processing is the concrete contents of step S54 in FIG. 26.

First, the memory control unit 58 analyzes the header information added to the write request, determines the master, that is, determines the access source (S81) and, from this determination result, determines whether the access source is the target of the RMW reduction function or not (S82).

At step S82, the memory control unit 58 refers to the on/off register 320, if determining that the RMW enable is “1,” determines that the access source is in the status where the RMW reduction operation is on, searches the address buffer 312 with reference to the search target write address (S83), and determines whether the search target write address is a hit in the middle access area or not (S84).

At this time, if the write address exists in the address buffer 312, [the memory control unit 58] reads the data corresponding to the write address from the memory 50 (S85), reads the data from the data buffer 310 corresponding to the write address (S86), generates 64 B data as modified data by combining the data read from the memory 50 and the data read from the data buffer 310, writes the generated modified data to the memory 50 (S87), deletes the address buffer 312 corresponding to the write address (S88), and returns to the processing at step S83.

Meanwhile, if determining at step S84 that the write address is not a hit in the middle access area, the memory control unit 58 determines whether the write address (the address of the write data) is a hit with the start address or not (S89).

The memory control unit 58, if determining at step S89 that the start address (head address) of the write address is a hit with an address existing in the address buffer 312, reads the data corresponding to the write address from the memory 50 (S90), reads the data corresponding to the write address from the data buffer 310 (S91), and deletes the address buffer 312 corresponding to the write address (S92).

Next, the memory control unit 58 determines whether that the end address is the border of 64 B or that the data is the transferred [data] equal to or smaller than 64 B (S93) and, if the end address is the border of 64 B, performs the RMW reduction operation for the head data and only performs the write operation for writing the 64 B data to the memory 50 for the other data (64 B data) following the head data (S94) or, if determining at step S93 that the data is the transferred [data] equal to or smaller than 64 B, performs the RMW reduction operation for the head data. In this case, the data acquired by the RMW reduction operation is smaller than 64 B. Therefore, the memory control unit 58 performs the RMW operation for the data acquired by the RMW reduction operation, if the data generated by combining the data read from the memory 50 and the data read from the data buffer 310 satisfies 64 B, that is, if [the above-mentioned data] satisfies the condition of the access unit (the data satisfies the specified value), writes the combined data to the memory 50 (S94), subsequently, determines whether the transfer of the head data is completed or not (S95) and, if the transfer of the head data is not completed, repeats the processing of step S94 and step S95 or, if the transfer of the head data is completed, ends the processing of this routine.

If determining at step S93 that the end address is not the border of 64 B and that the data is not the transferred [data] equal to or smaller than 64 B, the memory control unit 58, considering that the last data is smaller than 64 B, performs the RMW reduction operation for the head data and only performs the write operation for writing the 64 B data to the memory 50 for the other data (64 B data) following the head data except the last data (S96), in this process, determines whether [the data is] the last data or not (S97), and repeats the processing of step S96 and step S97 until the last data is processed. If the data to be processed is the last data, as the last data is smaller than 64 B, the memory control unit 58 stores the last data in the data buffer 310 (S98), registers the address corresponding to the last data in the address buffer 312 (S99), and ends the processing of this routine.

Furthermore, if determining at step S89 that the write address is not a hit with the start address, the memory control unit 58 determines whether that the end address is the border of 64 B or that the data is the transferred [data] equal to or smaller than 64 B (S100) and, if acquiring an affirmative result at this determination, that is, if the end address is the border of 64 B, only performs the write operation for writing the 64 B data to the memory 50 (S101) or, if determining at step S100 that the data is the transferred [data] equal to or smaller than 64 B, [the memory control unit 58] performs the RMW reduction operation for the head data. In this case, the data acquired by the RMW reduction operation is smaller than 64 B. Therefore, the memory control unit 58 performs the RMW operation for the data acquired by the RMW reduction operation, if the data generated by combining the data read from the memory 50 and the data read from the data buffer 310 satisfies 64 B, that is, if [the data] satisfies the condition of the access unit (the data satisfies the specified value), writes the combined data to the memory 50 (S101), subsequently, determines whether the transfer of the head data is completed or not (S102) and, if the transfer of the head data is not completed, repeats the processing of step S101 and step S102 or, if the transfer of the head data is completed, ends the processing of this routine.

Meanwhile, if determining at step S100 that the end address is not the border of 64 B and that the data is not the transferred [data] equal to or smaller than 64 B, the memory control unit 58 determines whether the address buffer 312 is full or not (S103).

If determining that the address buffer 312 is full, the memory control unit 58 reads the data corresponding to the write data from the memory 50 (S104), reads the data in the data buffer 310 in which the oldest data of the data buffer 310 is stored (S105), generates 64 B modified data by combining the data read from the memory 50 and the oldest data read from the data buffer 310, writes the generated modified data to the memory 50 (S106), deletes the address buffer 312 corresponding to the data buffer 310 in which the oldest data is stored (S107), and returns to the processing at step S83.

If determining at step S103 that the address buffer 312 is not full, the memory control unit 58 performs the RMW reduction operation for the head data and only performs the write operation for writing the 64 B data to the memory 50 for the other data (64 B data) following the head data except the last data (S108), in this process, determines whether [the data is] the last data or not (S109), and repeats the processing of step S108 and step S109 until the last data is processed. If the data to be processed is the last data, as the last data is smaller than 64 B, the memory control unit 58 writes the last data among write data in the data buffer 310 (S110), registers the address corresponding to the data buffer 310 in which the last data is stored in the address buffer 312 (S111), and ends the processing of this routine.

Meanwhile, if determining at step S82 that the access source is not the target of the RMW reduction function, the memory control unit 58 determines whether the write data is in the 64 B access unit or not (S112) and, if determining that the write data is the 64 B access unit, performs the processing for writing the write data to the memory 50 (S113), and ends the processing of this routine.

Meanwhile, if determining at step S112 that the write data is not the 64 B access unit, that is, if determining that the write data is smaller than 64 B, as the RMW reduction function is off, the memory control unit 58 performs the RMW operation for writing the write data to the memory 50 without writing the write data to the data buffer 310 (S114), and ends the processing of this routine.

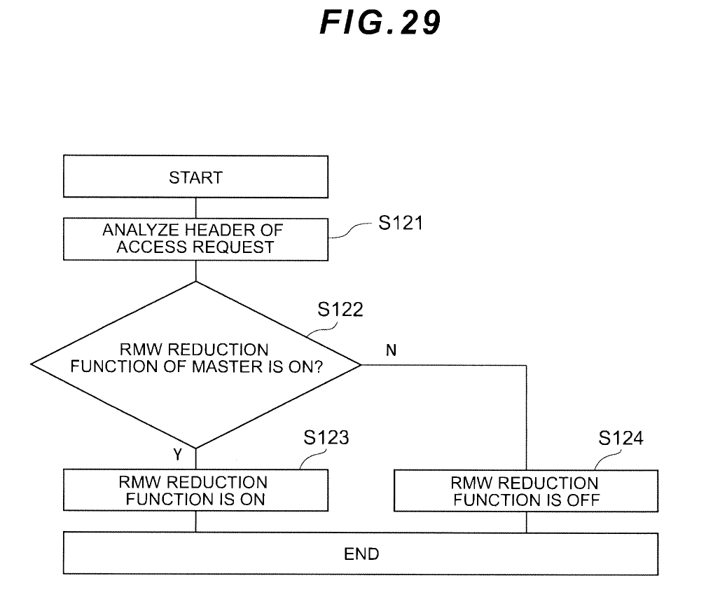

Next, the processing for determining whether to perform the RMW reduction operation or not in accordance with the access source is explained with reference to the flowchart in FIG. 29.

The memory control unit 58 analyzes the header information by referring to the on/off register 320 with reference to header information and determines whether the RMW reduction function is on or not in the access source (master) (S122).

The memory control unit 58, if determining that the RMW enable is equal to 1 by referring to the on/off register 320, determines that the RMW reduction function is on in the access source, outputs this determination result (S123), and ends the processing of this routine.

Specifically speaking, the memory control unit 58, during access to the memory 50, if determining that the access source (master) of the processing data is any of the Fibre Channel control unit 44, the DMA 56, or the device interface control unit 52, considers that the RMW reduction function is on and, on condition that the processing data is smaller than 64 B, performs the operation for storing the data smaller than 64 B in the buffer 96 (RMW reduction operation).

Meanwhile, if determining at step S122 that the RMW enable is equal to 0 and that the RMW reduction function is off in the access source, the memory control unit 58 outputs the determination result that the RMW reduction function is off (S124), and ends the processing of this routine.

Specifically speaking, the memory control unit 58, during access to the memory 50, if determining that the access source (master) of the processing data is the shared memory control unit 54, considers that the RMW reduction function is off, generates the data by the access unit (64 B data) by combining the data stored in the buffer 96 (data smaller than 64 B) and the data in the memory (data in the shared memory 90), and performs the Read Modify Write operation for writing the generated data in the access unit to the shared memory 90 in the memory 50.

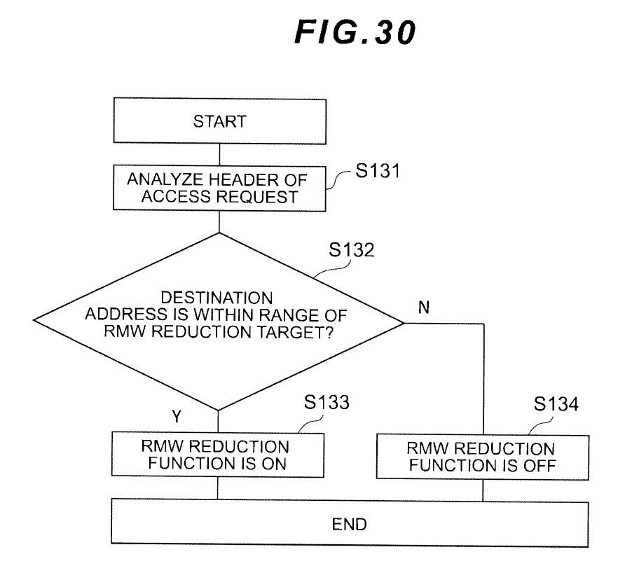

Next, the processing for determining whether to perform the RMW reduction operation or not in accordance with the data write destination address is explained with reference to the flowchart in FIG. 30.

The memory control unit 58 refers to the on/off register 318 with reference to header information and performs the processing for analyzing the header information (S131).

Next, the memory control unit 58 determines whether the destination address which becomes the data write destination is within the range of the RMW reduction target addresses with reference to the information of the on/off register 318 (S132).

If the destination address is stored in the start address 420 and in the end address 422 of the on/off register 318, the memory control unit 58 determines that the destination address is within the range of the RMW reduction target addresses, outputs that the RMW reduction function is set to on as a determination result (S133), and ends the processing of this routine.

Specifically speaking, the memory control unit 58, during access to the memory 50, if determining that the write destination of the processing data is a storage area which is different from the shared memory 90 in a plurality of storage areas belonging to the memory 50, for example, the cache memory 94, considers that the RMW reduction function is on and, on condition that the processing data is smaller than 64 B, performs operation for storing the data smaller than 64 B in the buffer 96 (RMW reduction operation).

Meanwhile, if determining at step S132 that the destination address is not within the range of the RMW reduction target addresses, that is, if the destination address is not within the range of the start address 420 and the end address 422 of the on/off register 318, the memory control unit 58 outputs that the RMW reduction function is set to off as a determination result (S134), and ends the processing of this routine.

Specifically speaking, the memory control unit 58, during access to the memory 50, if determining that the write destination of the processing data is the shared memory 90 among a plurality of storage areas belonging to the memory 50, considers that the RMW reduction function is off, generates the data by the access unit (64 B data) by combining the data stored in the buffer 96 (data smaller than 64 B) and the data in the memory (data in the shared memory 90), and performs the Read Modify Write operation for writing the generated data in the access unit to the shared memory 90 in the memory 50.

According to this embodiment, the memory control unit 58, during access to the memory 50, if data smaller than 64 B occurs in the processing data to be the processing target, temporarily stores the data smaller than 64 B in the buffer 96, subsequently combines the input processing data and the data stored in the buffer 96, on condition that the combined data is by the access unit, performs the RMW reduction operation as an operation for writing the combined data to the memory 50, and therefore can reduce the Read Modify Write operation for the memory 50.

Furthermore, according to this embodiment, if a certain period of time elapses since the data is stored in the buffer 96, it is made possible to store the data of the buffer 96 in the memory 50, which can prevent the data smaller than 64 B being stored in the buffer 96 unnecessarily.

Furthermore, according to this embodiment, in processing the data, it is determined whether the RMW reduction function is on or off, therefore the RMW reduction operation or the RMW operation can be immediately performed in accordance with the determination result.

Furthermore, according to this embodiment, for transmitting and receiving data between the memory control unit 58 and the shared memory control unit 54, as the operation accompanying this data transmission/reception is excluded from the target of the RMW reduction operation, the size of the buffer 96 can be inhibited from increasing.

It should be noted that the present invention is not limited to the above-mentioned embodiment, and includes various types of variations. For example, the above-mentioned embodiment is explained in detail for the purpose of easy explanation of the present invention, and is not necessarily limited to what comprises all the explained configurations. Furthermore, it is possible to replace a part of the configuration of an embodiment by the configuration of another embodiment, and it is also possible to add the configuration of another embodiment to the configuration of an embodiment. Furthermore, for a part of the configuration of the respective embodiments, addition, deletion, and replacement of another configuration may be performed.

Furthermore, the above-mentioned respective configurations, functions, processing units, processing means and others may also be achieved partially or entirely by hardware, for example, by designing in the integrated circuit or others. Furthermore, the above-mentioned respective configurations, functions, and others may also be achieved by software through the processor interpreting programs achieving the respective functions and performing the same. The information in programs, tables, files and others for achieving the respective functions can be recorded in recording devices such as memories, hard disks, and SSDs (Solid State Drives) or recording media such as IC (Integrated Circuit) cards, SD (Secure Digital) memory cards, and DVDs (Digital Versatile Disks).

### Reference Sign List

30, 32, 34 Host computer, 36 Disk array device, 38 Network, 40 Disk array control unit, 42 Storage unit, 44 Fibre Channel control unit, 46 Microprocessor, 48 Data transfer control unit, 50 Memory, 52 Device interface control unit, 54 Shared memory control unit, 56 DMA, 58 Memory control unit, 82 Storage devices, 96 Buffer, 300 RMW reduction determination block, 302 RMW control unit, 308 Header analysis unit, 310 Data buffer, 312 Address buffer, 316 Counter.

1. A storage apparatus, comprising:
a storage unit (42) having a plurality of storage devices;
a first interface control unit (44) which exchanges data with an access request source (30, 32, 34) via a network (38);
a second interface control unit (52) which controls data inputs/outputs to and from the storage unit;
a memory (50) having a plurality of storage areas;
a memory control unit (58) which exchanges data with each of the interface control units based on an access request from the access request source and which accesses the memory using data of an access unit; and
a buffer (96) which temporarily stores data which lies outside prescribed values prescribing the access unit,
wherein if, among the data exchanged between the memory control unit and the memory upon accessing the memory, processing data to be processed at the time of access configures the access unit, the memory control unit (58) accesses the memory using the processing data, and if the processing data lies outside the prescribed values, the memory control unit (58) stores the processing data which lies outside the prescribed values in the buffer and, subsequently, if new processing data which is processing data that is to be processed at the time of the access is associated with the processing data which lies outside the prescribed values that is stored in the buffer, the memory control unit (58) combines the new processing data with the processing data which lies outside the prescribed values that is stored in the buffer and, on condition that the combined processing data is configured from the prescribed values, accesses the memory using the combined processing data.

2. The storage apparatus according to claim 1,
wherein the memory control unit starts a timer from a point in time where the processing data which lies outside the prescribed values is stored in the buffer and, on condition that a prescribed time has elapsed since the timer start time, the memory control unit combines the processing data for which the prescribed time has elapsed among the processing data which lies outside the prescribed values that is stored in the buffer with the memory data to generate data of the access unit, and executes a Read Modify Write operation in which the generated access unit data is written to the memory.

3. The storage apparatus according to claim 1,
wherein the memory control unit distinguishes a master indicating an access source of the processing data which lies outside the prescribed values as a master within the target for which a specific operation is executed which is a master that comprises each of the interface control units or as a master outside the target which is excluded from the execution of the specific operation, and if the master is the master outside the target, the memory control unit combines the processing data which lies outside the prescribed values that is stored in the buffer with the memory data to generate data of the access unit, and executes a Read Modify Write operation in which the generated access unit data is written to the memory.

4. The storage apparatus according to claim 3,
wherein, if the master is the master within the target which is a master that comprises each of the interface control units and, on condition that the processing data lies outside the prescribed values, the memory control unit stores the processing data which lies outside the prescribed values in the buffer.

5. The storage apparatus according to claim 1,
wherein, if a time of no access to the memory exceeds a threshold, the memory control unit combines the processing data which lies outside the prescribed values that is stored in the buffer with the memory data to generate data of the access unit, and executes a Read Modify Write operation in which the generated access unit data is written to the memory.

6. The storage apparatus according to claim 1,
wherein, upon accessing the memory, the memory control unit distinguishes a write destination of the processing data to be processed at the time of access, and if the write destination of the processing data is a shared storage area among the plurality of storage areas belonging to the memory, the memory control unit combines the processing data which lies outside the prescribed values that is stored in the buffer with the memory data to generate data of the access unit, and executes a Read Modify Write operation in which the generated access unit data is written to the memory.

7. The storage apparatus according to claim 6,
wherein, if the write destination of the processing data is a different storage area from the shared storage area among the plurality of storage areas belonging to the memory and, on condition that the processing data lies outside the prescribed values, the memory control unit stores the processing data which lies outside the prescribed values in the buffer.

8. The storage apparatus according to claim 1,
wherein, upon accessing the memory, the memory control unit distinguishes a destination address of the processing data to be processed at the time of access, and if the destination address of the processing data lies outside an address range for a Read Modify Write reduction target, the memory control unit combines the processing data which lies outside the prescribed values that is stored in the buffer with the memory data to generate data of the access unit, and executes a Read Modify Write operation in which the generated access unit data is written to the memory.

9. The storage apparatus according to claim 8,
wherein, if the destination address of the processing data lies within the address range for a Read Modify Write reduction target and, on condition that the processing data lies outside the prescribed values, the memory control unit stores the processing data which lies outside the prescribed values in the buffer.

10. The storage apparatus according to claim 1,
wherein, if the access request from the access request source is a write access request, the memory control unit distinguishes the addresses of a plurality of processing data to be processed at the time of write access to the memory among the plurality of data which is exchanged between the memory control unit and the memory at the time of write access, and if the processing data at the last address among the plurality of processing data lies outside the prescribed values, the memory control unit stores the processing data at the last address in the buffer, and if subsequently the address of the new processing data which is processing data to be processed at the time of the write access is sequential to the address of the processing data which lies outside the prescribed values that is stored in the buffer, the memory control unit combines the new processing data with the processing data which lies outside the prescribed values that is stored in the buffer and, on condition that the combined processing data is configured from the prescribed values, writes the combined processing data to the memory.

11. The storage apparatus according to claim 1,
wherein, if the access request from the access request source is a read access request, and if at the time of read access to the memory, among the data present in the memory the address of the data which is a processing target of the read access request and the address of the data which lies outside the prescribed values present in the buffer are not a hit, the memory control unit reads the data which is a processing target of the read access request from the memory as read data, and if the address of the data which is a processing target of the read access request and the data which lies outside the prescribed values present in the buffer are a hit, the memory control unit combines the data which lies outside the prescribed values that is stored in the memory with the data which lies outside the prescribed values that is present in the buffer and writes the combined data to the memory as combined data, and reads the combined data written to the memory from the memory as read data.

12. The storage apparatus according to claim 1, further comprising:
a direct memory access unit which processes the processing data to be processed at the time of access; and
a shared memory control unit which controls control information which is to be stored in the memory,
wherein the memory control unit manages each of the interface control units and the direct memory access unit and the shared memory control unit as masters indicating the access source of the processing data to be processed at the time of the access, manages each of the interface control units and the direct memory access unit as masters within the target for which a specific operation is executed, and manages the shared memory control unit as a master outside the target which is excluded from the execution of the specific operation, and at the time of the access to the memory, the memory control unit distinguishes whether the master indicating the access source of the processing data to be processed at the time of the access is the master within the target or the master outside the target, and if the master is the master outside the target, combines the processing data which lies outside the prescribed values that is stored in the buffer with the memory data to generate data of the access unit, and executes a Read Modify Write operation in which the generated access unit data is written to the memory.

13. The storage apparatus according to claim 10,
wherein if the master is the master within the target and, on condition that the processing data lies outside the prescribed values, the memory control unit stores the processing data which lies outside the prescribed values in the buffer.

14. A data processing method of a storage apparatus that comprises a storage unit (42) having a plurality of storage devices; a first interface control unit (44) which exchanges data with an access request source (30, 32, 34) via a network (38);a second interface control unit (52) which controls data inputs/outputs to and from the storage unit; a memory (50) having a plurality of storage areas; a memory control unit (58) which exchanges data with each of the interface control units based on an access request from the access request source and which accesses the memory using data of an access unit; and a buffer (96) which temporarily stores data which lies outside prescribed values prescribing the access unit,
wherein if, among the data exchanged between the memory control unit and the memory upon accessing the memory, processing data to be processed at the time of access configures the access unit, the memory control unit (58) accesses the memory using the processing data, and if the processing data lies outside the prescribed values, the memory control unit (58) stores the processing data which lies outside the prescribed values in the buffer and, subsequently, if new processing data which is processing data that is to be processed at the time of the access is associated with the processing data which lies outside the prescribed values that is stored in the buffer, the memory control unit (58) combines the new processing data with the processing data which lies outside the prescribed values that is stored in the buffer and, on condition that the combined processing data is configured from the prescribed values, accesses the memory using the combined processing data.

15. The data processing method of a storage apparatus according to claim 14,
wherein the memory control unit starts a timer from a point in time where the processing data which lies outside the prescribed values is stored in the buffer and, on condition that a prescribed time has elapsed since the timer start time, the memory control unit combines the processing data for which the prescribed time has elapsed among the processing data which lies outside the prescribed values that is stored in the buffer with the memory data to generate data of the access unit, and executes a Read Modify Write operation in which the generated access unit data is written to the memory.
